(19) United States
(12) Patent Application Publication
(10) Pub. No.: US 2011/0157454 A1
(43) Pub. Date: Jun. 30, 2011

(54) IMAGE SENSOR AND IMAGING APPARATUS

(75) Inventor: Shohei MATSUOKA, Tokyo (JP)

(73) Assignee: HOYA CORPORATION, Tokyo (JP)

(21) Appl. No.: 12/827,547

(22) Filed: Jun. 30, 2010

(30) Foreign Application Priority Data
Dec. 25, 2009 (JP) 2009-296284
Jun. 24, 2010 (JP) 2010-144077

(51) Int. Cl. H04N 5/225

(52) U.S. Cl. 348/340; 348/E05.024

(57) ABSTRACT

An imaging sensor comprising a plurality of pixels is provided. Each pixel comprises photoelectric converters and optical members. The optical member covers the photoelectric converter. Light toward the photoelectric converter passes through the optical member. The pixels are arranged in two dimensions on a light-receiving area. At least a part of the light-receiving area comprises an area of irregularity. First and second pixels are arranged irregularly in the area of irregularity. Distances between the photoelectric converter and a far-side surface of the optical member are first and second distances in the first and second pixels, respectively. The far-side surface is an opposite surface of a near-side surface. The near-side surface of the optical member faces the photoelectric converter. The second distance is shorter than the first distance.

### BACKGROUND OF THE INVENTION

1. Field of the Invention

The present invention relates to an image sensor that can reduce the influence of a ghost image within an entire captured image.

2. Description of the Related Art

Noise referred to as a ghost image is known. A ghost image is generated when an image sensor captures an optical image that passes directly through an imaging optical system as well as a part of the optical image that is reflected between lenses of the optical system before finally reaching the image sensor. A solid-state image sensor that carries out photoelectric conversion for a received optical image and generates an image signal has been recently used for an imaging apparatus. It is known that a ghost image is generated by an image sensor that captures an entire optical image as well as a part of an optical image that has been reflected back and forth between the image sensor and imaging optical system before finally reaching the image sensor again.

Japanese Unexamined Patent Publication No. 2006-332433 discloses a micro-lens array that has many micro lens facing each pixel, and where the micro lenses have fine dimpled surfaces. By forming such micro lenses, the reflection at the surfaces of the micro lenses is decreased and the influence of a ghost image is reduced.

The ghost image generated by the reflection of light between the lenses of the imaging optical system has a shape similar to a diaphragm, such as a circular or polygonal shape. The ghost image having such a shape is sometimes used as a special photographic special effect even though it is noise.

However, the ghost image generated based on the reflection of light between the image sensor and the lens is an image of a repeating pattern of alternating brightness and darkness, because the micro-lens array works as a diffraction grating. Accordingly, the ghost image generated based on the reflection between the image sensor and the lens has a polka-dot pattern.

Such a polka-dot ghost image is more unnatural and noticeable than a ghost image generated by light reflected between the lenses. Accordingly, even if the light reflected by the micro lens is reduced according to the above Japanese Unexamined Patent Publication, an entire image still includes an unnatural and noticeable pattern.

### SUMMARY OF THE INVENTION

Therefore, an object of the present invention is to provide an image sensor that can effectively reduce the influence of a ghost image generated by the reflection of an image between an image sensor and the lens.

According to the present invention, an image sensor, comprising a plurality of pixels is provided. The pixel comprises photoelectric converters and optical members. The optical member covers the photoelectric converter. Light toward the photoelectric converter passes through the optical member. The pixels are arranged in two dimensions on a light-receiving area. At least a part of the light-receiving area comprises an area of irregularity. First and second pixels are arranged irregularly in the area of irregularity. Distances between the photoelectric converter and a far-side surface of the optical member is first and second distances in the first and second pixels, respectively. The far-side surface is an opposite surface of a near-side surface. The near-side surface of the optical member faces the photoelectric converter. The second distance is shorter than the first distance.

### BRIEF DESCRIPTION OF THE DRAWINGS

The objects and advantages of the present invention will be better understood from the following description, with reference to the accompanying drawings in which:

FIG. 1 shows a condition where the ghost image is generated based on the reflection between the lenses;

FIG. 2 shows a condition where the ghost image is generated based on the reflection between the image sensor and the lens;

FIG. 3 is a sectional view of the image sensor of the first embodiment;

FIG. 4A is a sectional view of the image sensor of the first embodiment showing the variation of the diffraction angle;

FIG. 4B is a sectional view of the image sensor of the first embodiment showing the reflection of light at the external surface of the micro-lens array;

FIG. 4C is a sectional view of the image sensor of the first embodiment showing the reflection of light at the internal surface of the micro-lens array;

FIG. 5 is a sectional view of the image sensor of the first embodiment for explanation of the external and internal optical path length in the first embodiment;

FIG. 6 is a polka-dot pattern of the ghost image generated by various image sensors;

FIG. 7 is a plane view of apart of the image sensor;

FIG. 8 is a polka-dot pattern of the r-d-ghost image for different colored light;

FIG. 9 shows the directions of diffraction light generated between two neighboring pixels;

FIG. 10 shows an optical image of the sun formed on the pixel-unit;

FIG. 11 is a sectional view of the image sensor of the second embodiment;

FIG. 12 is a sectional view of the image sensor of the third embodiment;

FIG. 13 is a sectional view of the image sensor of the fourth embodiment;

FIG. 14 is a sectional view of the image sensor of the fifth embodiment;

FIG. 15 is a sectional view of another image sensor of the fifth embodiment;

FIG. 16 is a sectional view of the image sensor of the first embodiment showing the reflection of light at electrical wires mounted in the image sensor;

FIG. 17 is a sectional view of another image sensor which has the e-r-difference for generation of the phase difference;

FIG. 18A is a deployment diagram showing the arrangement of the lengthened pixel in the pixel-unit of the first example;

FIGS. 18B-18D show whether or not the ratio of the lengthened pixels to all the pixels in the first area ranges between 25%-75% in the first example;

FIG. 19 shows the contrast of the diffraction light of the first example;

FIG. 20A is a deployment diagram showing the arrangement of the lengthened pixel in the pixel-unit of the second example;

FIGS. 20B-20D show whether or not the ratio of the lengthened pixels to all the pixels in the first area ranges between 25%-75% in the second example;

FIG. 21 shows the contrast of the diffraction light the second example;

FIG. 22A is a deployment diagram showing the arrangement of the lengthened pixel in the pixel-unit of the third example;

FIGS. 22B-22D show whether or not the ratio of the lengthened pixels to all the pixels in the first area ranges between 25%-75% in the third example;

FIG. 23 shows the contrast of the diffraction light of the third example;

FIG. 24A is a deployment diagram showing the arrangement of the lengthened pixel in the pixel-unit of the fourth example;

FIGS. 24B-24D show whether or not the ratio of the lengthened pixels to all the pixels in the first area ranges between 25%-75% in the fourth example;

FIG. 25 shows the contrast of the diffraction light of the fourth example;

FIG. 26A is a deployment diagram showing the arrangement of the lengthened pixel in the pixel-unit of the fifth example;

FIGS. 26B-26D show whether or not the ratio of the lengthened pixels to all the pixels in the first area ranges between 25%-75% in the fifth example;

FIG. 27 shows the contrast of the diffraction light of the fifth example;

FIG. 28A is a deployment diagram showing the arrangement of the lengthened pixel in the pixel-unit of the sixth example;

FIGS. 28B-28D show whether or not the ratio of the lengthened pixels to all the pixels in the first area ranges between 25%-75% in the sixth example;

FIG. 29 shows the contrast of the diffraction light of the sixth example;

FIG. 30A is a deployment diagram showing the arrangement of the lengthened pixel in the pixel-unit of the seventh example;

FIGS. 30B-30D show whether or not the ratio of the lengthened pixels to all the pixels in the first area ranges between 25%-75% in the seventh example;

FIG. 31 shows the contrast of the diffraction light of the seventh example;

FIG. 32A is a deployment diagram showing the arrangement of the lengthened pixel in the pixel-unit of the comparative example;

FIGS. 32B-32D show whether or not the ratio of the lengthened pixels to all the pixels in the first area ranges between 25%-75% in the comparative example; and

FIG. 33 shows the contrast of the diffraction light of the comparative example.

### DESCRIPTION OF THE PREFERRED EMBODIMENTS

The present invention is described below with references to the embodiments shown in the drawings.

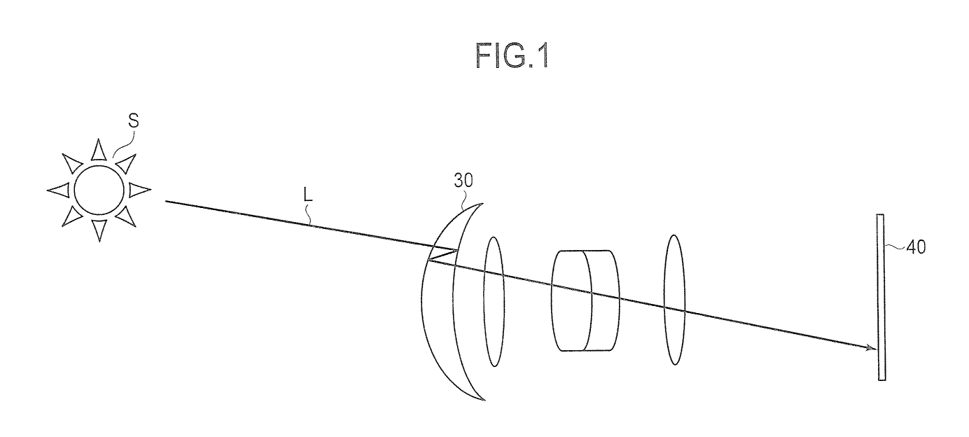

It is known that sunlight incident on an optical system of an imaging apparatus (not depicted) causes a ghost image to be captured in a photographed image. For example, as shown in FIG. 1, a ghost image is generated when incident light (see “L”) reflected inside a lens of an imaging optical system 30 is made incident on an image sensor 40. The ghost image has a single circular shape or a polygonal shape.

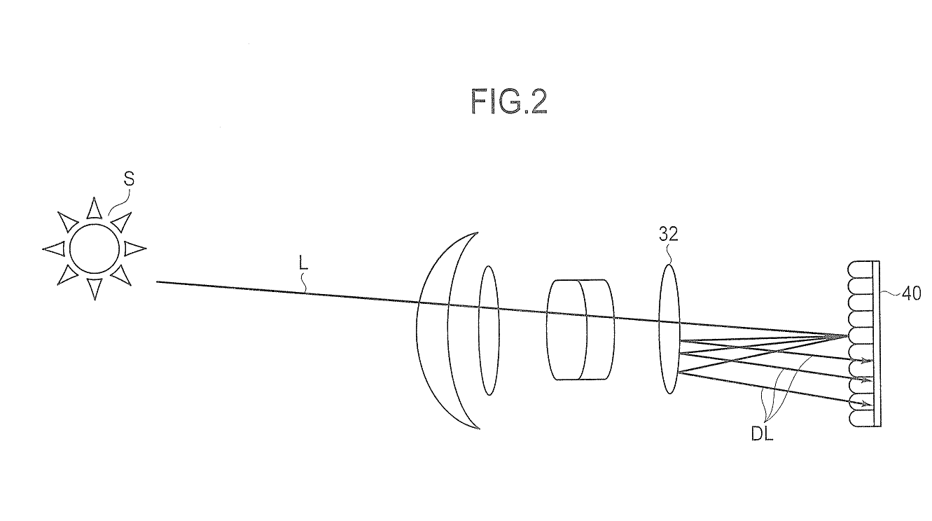

On the other hand, as shown in FIG. 2, when incident light is reflected by an image sensor 40, a plurality of beams of diffraction light (see “DL”) travels in various directions. The plurality of beams of light is reflected again by a lens 32 of the imaging optical system 30 and made incident on the image sensor 40. Accordingly, the ghost image generated by the plurality of beams has a polka-dot pattern in which a plurality of bright dots is arranged.

Such a polka-dot pattern causes the image quality of a photoelectric converted image to deteriorate. In the embodiment, the shape or pattern of a ghost image changes when improvements specifically designed to improve the image quality are made to the structure of an image sensor, as described below.

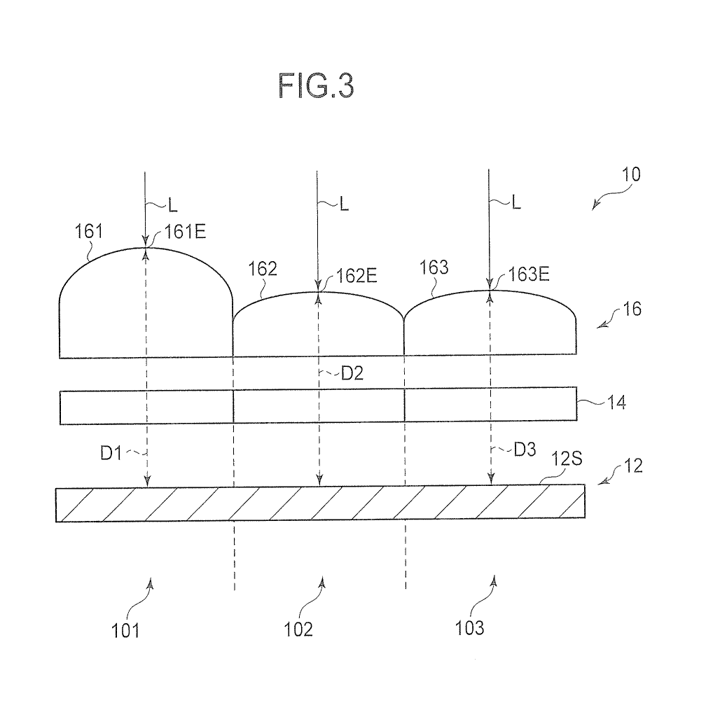

As shown in FIG. 3, an image sensor 10 of the first embodiment comprises a photoelectric conversion layer 12, a color filter 14, and micro-lens array 16. Light incident on the image sensor 10 strikes the micro-lens array 16, which is located at the outside surface of the image sensor 10.

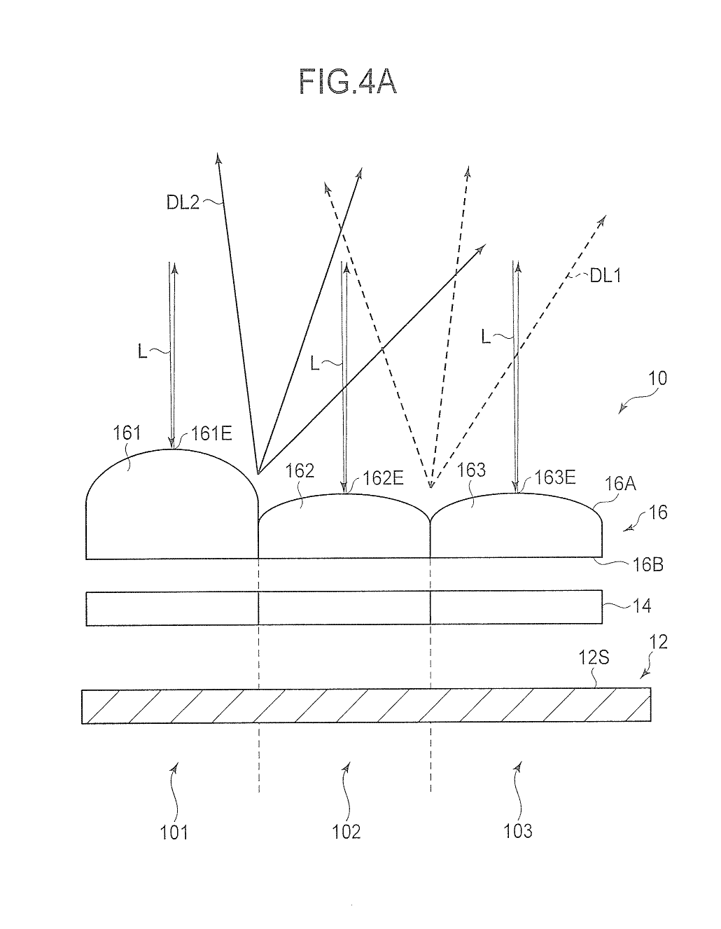

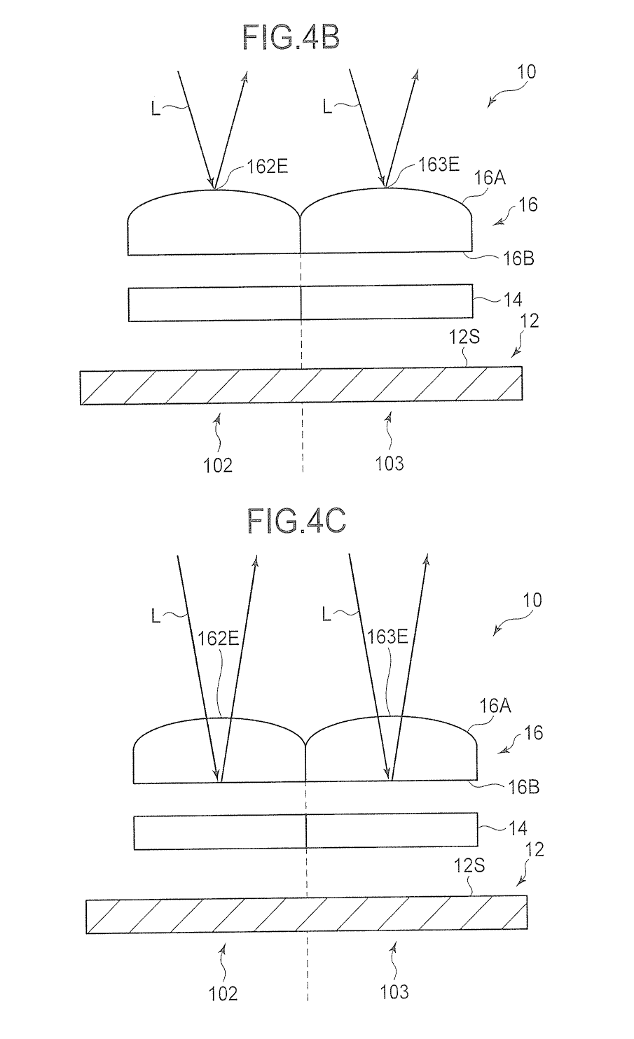

As shown in FIGS. 4A and 4B, one part of the incident light (see “L”) passes through an external surface 16A (far-side surface) of the micro-lens array 16, and the other part of the incident light is reflected by the external surface 16A. As shown in FIG. 4C, the part of the light passing through the external surface 16A passes an internal surface 16B (near-side surface) of the micro-lens array 16, and the other part of the light passing through the external surface 16A is reflected by the internal surface 16B.

In the first embodiment, the image sensor 10 comprises a plurality of pixels. Each of the pixels comprises one photoelectric converter of which a plurality is arranged on the photoelectric conversion layer 12, one color filter of which a plurality is arranged on the color filter layer 14, and one micro lens of which a plurality is arranged on the micro-lens array 16.

In the image sensor 10, the micro-lens array 16 is formed as one body so that micro lenses having different thickness are arranged irregularly. Here, the thickness of the micro lens is the length between the top of the micro lens, for example a top point 161E of the external surface 16E, and the internal surface 16B.

For example, a first micro lens 161 of a first pixel 101 is formed so that the thickness of the first micro lens 161 is greater than the thickness of second and third micro lenses 162, 163 of second and third pixels 102, 103. In addition, the second and third micro lenses 162, 163 are formed so that their thicknesses are equal to each other.

Accordingly, distances (see “D2” and “D3” in FIG. 3) between the top points 162E, 163E of the second and third micro lens 162, 163 and the photoelectric conversion layer 12 (first distance) are shorter than that (see “D1”) between the top point 161E of the first micro lens 161 and the photoelectric conversion layer 12 (second distance).

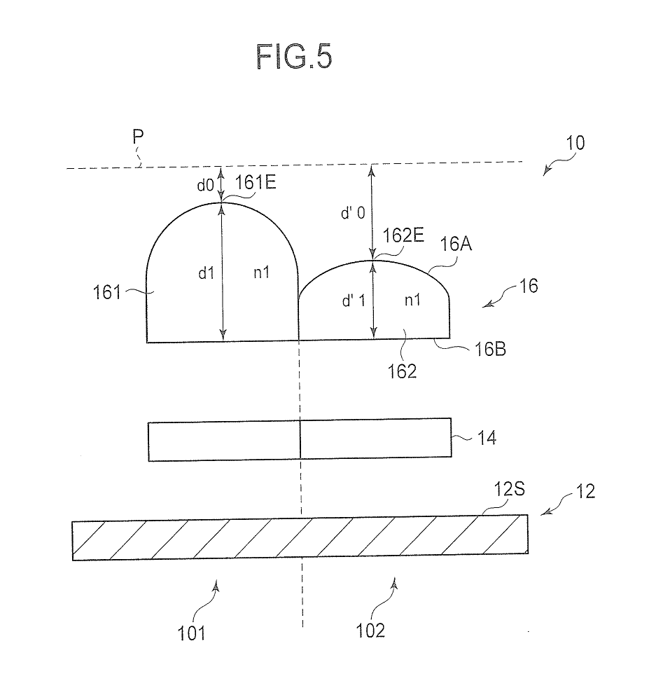

Next, external and internal optical path lengths (OPLs) are explained below. For the explanation of the external and internal OPL, a plane which is a parallel to a light-receiving area of the photoelectric conversion layer 12 and further from the photoelectric conversion layer 12 than the micro lens array 16 is defined as an imagined plane (see “P” in FIG. 5).

The external OPL is an integral value of the thickness of the substances and spaces between the imagined plane and the external surface 16A of the micro-lens array 16 multiplied by the respective refractive indexes of the substances and spaces. The internal OPL is an integral value of the thickness of the substances and spaces between the imagined plane and the internal surface 16B of the micro-lens array 16 multiplied by the respective refractive indexes of the subjects and spaces. In the first embodiment, the thickness of the respective substances and spaces used for the calculation of the external and internal OPLs is their length along a straight line that passes through the top point of the micro lens and is perpendicular to the light-receiving area of the photoelectric conversion layer 12.

For example, as shown in FIG. 5, the external OPL of the first and second pixels 101, 102 are (d0×n0) and (d′0×n0), respectively. An optical path length of light that travels from the imagined plane to the external surface 16A and is reflected by the external surface 16A back to the imagined plane is defined as an external reflected OPL. The external reflected OPL is twice as long as the external OPL.

Accordingly, the difference of the external reflected OPL, hereinafter referred to as e-r-difference, between the first and second pixels 101, 102 is calculated as ((d′0×n0)−(d0×n0))×2. It is clear from the equation that the e-r-difference is the difference between the external reflected OPL of light going and returning.

In the first embodiment, by varying per pixel the distance from the photoelectric conversion layer 12 to the external surface 16E of the micro lens 16, the e-r-difference of (distance from photoelectric conversion layer 12 to external surface 16E)×(refractive index of air)×2 is generated between two pixels.

In FIG. 5, the internal OPLs of the first and second pixels are (d0×n0)+(d1×n1) and (d′0×n0)+(d′1×n1), respectively. An optical path length of light that travels from the imagined plane to the internal surface 16B and is reflected by the internal surface 16B back to the imagined plane is defined as an internal reflected OPL. The internal reflected OPL is twice as long as the internal OPL.

Accordingly, the difference of the internal reflected OPL, hereinafter referred to as i-r-difference, between the first and second pixels 101, 102 is calculated as ((d′0×n0)+(d′1×n1)−(d0×n0)−(d1×n1))×2. Using the equation of (d′0+d′1)=(d0+d1), the i-r-difference is calculated as ((d1−d′1)×(n1−n0))×2. Accordingly, the i-r-difference is calculated as (difference between thickness of micro lenses)×(difference between refractive indexes of micro-lens array 16 and air)×2. In the above and below calculation, the refractive index is determined to be 1.

In the image sensor 10 having the e-r-difference or the i-r-difference, the direction of the diffraction light generated by the reflection of incident light at the external or internal surface 16A, 16B of a pair of pixels varies according to the dimensions of the pair of pixels.

For example, shown in FIG. 4A, the e-r-difference between the second and third pixels 102, 103 is mλ (m being an integer and zero in this case, and λ being the wavelength of light incident on the micro lens). Accordingly, the phases of the light reflected by the second and third pixels are the same. First diffraction light (see “DL1”) generated between the second and third pixels, of which the phases are same, travel in the directions indicated by the dashed lines.

On the other hand, the micro-lens array 16 is configured so that the difference in thickness between the micro lenses of the first and second pixels 101, 102 is (m+½)×λ. Accordingly, a phase difference is generated between the first and second pixels. Second diffraction light (see “DL2”) generated between the first and second pixels, of which the phases are different, travels in the directions indicated by the solid lines.

The direction of the second diffraction light is in the center direction between the directions of neighboring first diffraction light. Hereinafter, the diffraction light, which travels in the center direction between two directions of integer degree diffraction light, is called half-degree diffraction light. Similar to half-degree diffraction light, diffraction light that travels in the center direction between the directions of half- and integer-degree diffraction light is called quarter-degree diffraction light.

The directions of diffraction light can be increased by changing the direction of the diffraction light resulting from the external reflected OPL between two pixels. For example, by producing half-degree diffraction light the diffraction light that travels between zero- and one-degree diffraction light is generated.

In addition and similar to the e-r-difference, the directions of diffraction light based on the reflection at the internal surface can be increased by generating the i-r-difference between two pixels and changing the direction of the diffraction light.

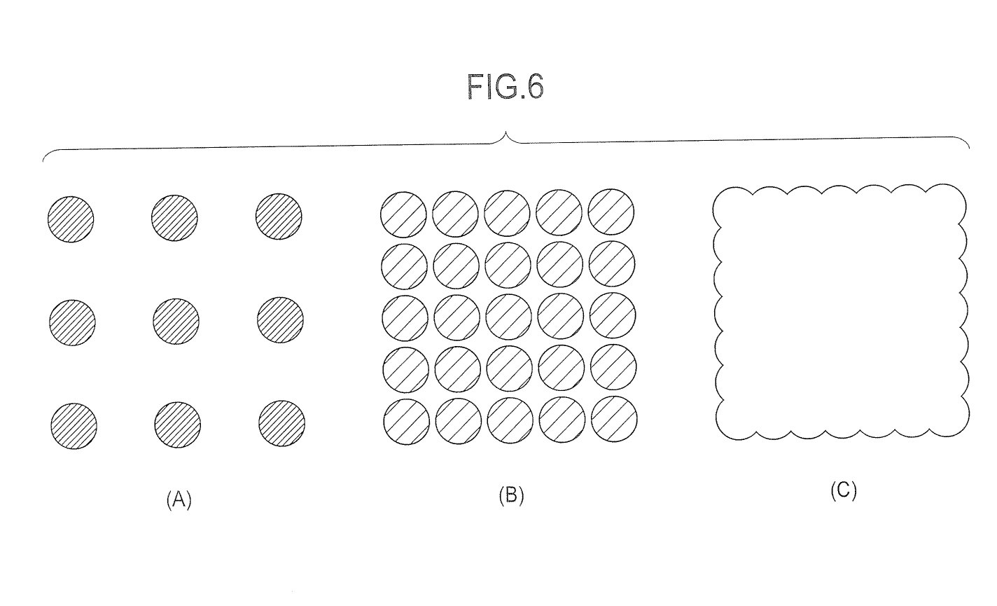

The contrast of a ghost image based on the diffraction light generated by reflection, hereinafter referred to as an r-d-ghost image, can be lowered by increasing the directions of the diffraction light. The mechanism to lower the contrast of the r-d-ghost image is explained below using FIG. 6, FIG. 6 is a polka-dot pattern of the ghost image generated by various image sensors.

Using the image sensor 40 (see FIG. 2), which has no e-r-difference between pixels, the generated diffraction light based on the reflection at either the external surface of the micro-lens array, the photoelectric converter, or a layer of electrical wiring in the image sensor, travels in the same directions between any pairs of pixels. Accordingly, as shown in FIG. 6A, the contrast of the ghost image based on the diffraction light using the image sensor 40 is relatively high. Consequently, the brightness of the dots in the polka-dot pattern of the ghost image are emphasized.

Using the image sensor of the first embodiment, the direction of partial diffraction light is changed and the diffraction light travels in various directions. Accordingly, as shown in FIGS. 6B and 6C, the contrast of the ghost image based on the diffraction light using the image sensor of the first embodiment is lowered.

Accordingly, even if the r-d-ghost image appears, each of the dots is unnoticeable because the number of dots within a certain size of the polka-dot pattern increases and the brightness of each dot decreases. Consequently, the image quality is prevented from deteriorating due to the r-d-ghost image. As described above, in the first embodiment the impact of the r-d-ghost image on an image to be captured is reduced, and a substantial appearance of the r-d-ghost image is prevented.

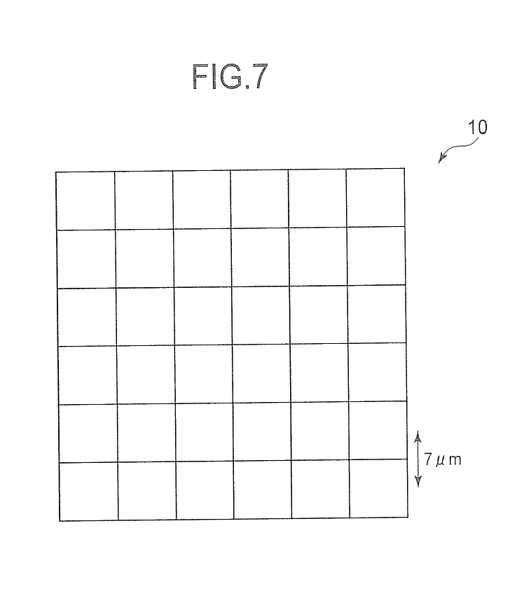

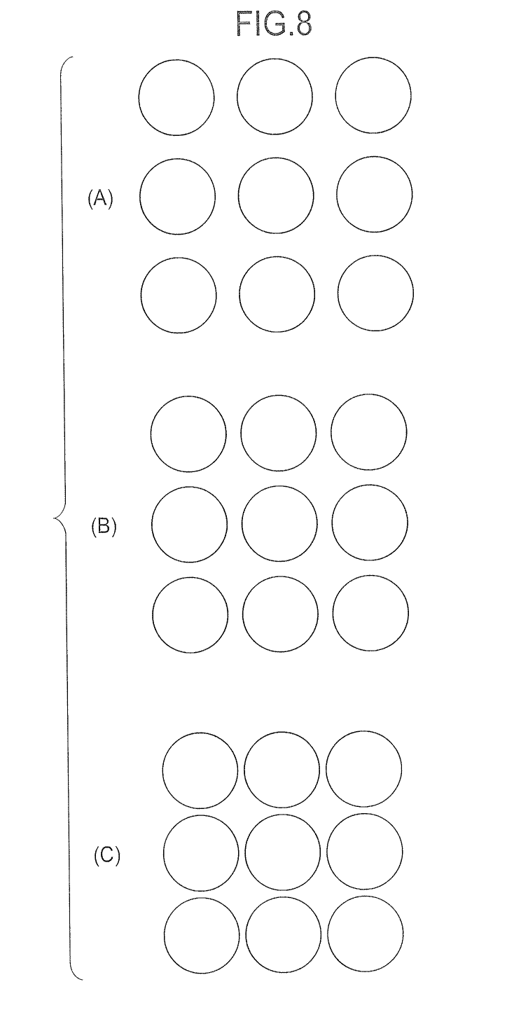

Next, the structure of the micro-lens array 16 that produces a phase difference in the reflected light between pixels is explained below using FIGS. 7 to 9. FIG. 7 is a plane view of a part of the image sensor 10. FIG. 8 is a polka-dot pattern of the r-d-ghost image for different colors of light.

In the image sensor 10, the pixels are two-dimensionally arranged in rows and columns. Each pixel comprises one of a red, green or blue color filter. The color filter layer 14 comprises red, green, and blue color filters. The red, green, and blue color filters are arranged according to the Bayer color array. Hereinafter, pixels having the red, green, and blue color filters are referred to as r-pixels, g-pixels and b-pixels, respectively.

The distance between two pixels that are nearest to each other, hereinafter referred to as a pixel distance, is 7 μm for example. The diffraction angle of the diffraction light (see “DL” in FIG. 4A) is calculated as (wavelength of reflected light)/(pixel distance). The angle between the directions in which diffraction light of two successive integer degrees travels, such as a combination of zero and one-degree diffraction light and a combination of one- and two-degree diffraction light, is defined as the diffraction angle.

The wavelength of the light reflected at the external and internal surface of the micro-lens array 16 varies broadly. However, for the purpose of reducing the influence of the r-d-ghost image it is sufficient to consider a diffraction angle that is calculated on the basis of one representative wavelength in the band of light reflected at the external and internal surface for each pixel.

The light that is reflected at the external or internal surface 16A, 16B of the micro-lens array 16 and reflected by the lens 32 (see FIG. 2) before traveling toward the image sensor 10 is white light because it does not pass through the color filter layer 14. However, the light eventually does pass through the color filter layer 14 and is made incident on the photoelectric conversion layer 12. Accordingly, it is sufficient to consider a diffraction angle using a certain wavelength in a wavelength band of light that passes through the color filter for each pixel for the purpose of reducing the influence of the r-d-ghost image.

For example, a representative wavelength in a wavelength band of red light that passes through the red color filter is determined to be 640 nm. A representative wavelength in a wavelength band of green light that passes through the green color filter is determined to be 530 nm. A representative wavelength in a wavelength band of blue light that passes through the blue color filter is determined to be 420 nm.

The pixel distance in the first embodiment is about 7 μm, as described above and shown in FIG. 7. Accordingly, the diffraction angle of the diffraction light generated based on the reflection at the external surface 16A of the r-pixel is 640 nm/7 μm=91 rad (see FIG. 8A). The diffraction angle of the diffraction light generated based on the reflection at the external surface 16A of the g-pixel is 530 nm/7 μm=76 rad (see FIG. 8B). The diffraction angle of the diffraction light generated based on the reflection at the external surface 16A of the b-pixel is 420 nm/7 μm=60 rad (see FIG. 8C).

As described above, the diffraction angle varies according to wavelength. In order to maximize the effect of lowering the contrast, m+0.5 degree diffraction light (m being a certain integer) is generated between two pixels. To generate the m+0.5 degree diffraction light, it is preferable to change the e-r-difference or the i-r-difference according to a wavelength within the wavelength band of the light that reaches the photoelectric conversion layer 12. In the first embodiment, it is preferable to change the e-r-difference or the i-r-difference according to wavelength of red, green or blue light.

However, even if the generated diffraction light is not m+0.5 degree diffraction light, the ghost image can still be adequately dispersed. Accordingly, calculation of the e-r-difference or the i-r-difference using the wavelength of 530 nm, which is the middle value among 640 nm, 530 nm, and 420 nm for the r-pixel, g-pixel and b-pixel, is sufficient to determine the shape of the micro-lens array that will reduce the effect of the ghost image. Even if the e-r-difference or i-r-difference is determined using the wavelength of 530 nm, the ghost image can be dispersed for the r-pixel and b-pixel.

In the first embodiment, the micro-lens array 16 is formed so that part of the pairs of pixels has the e-r-difference or the i-r-difference of (m+½)×λ (m being a certain integer and λ being 530 nm for the middle wavelength within the wavelength band of green light).

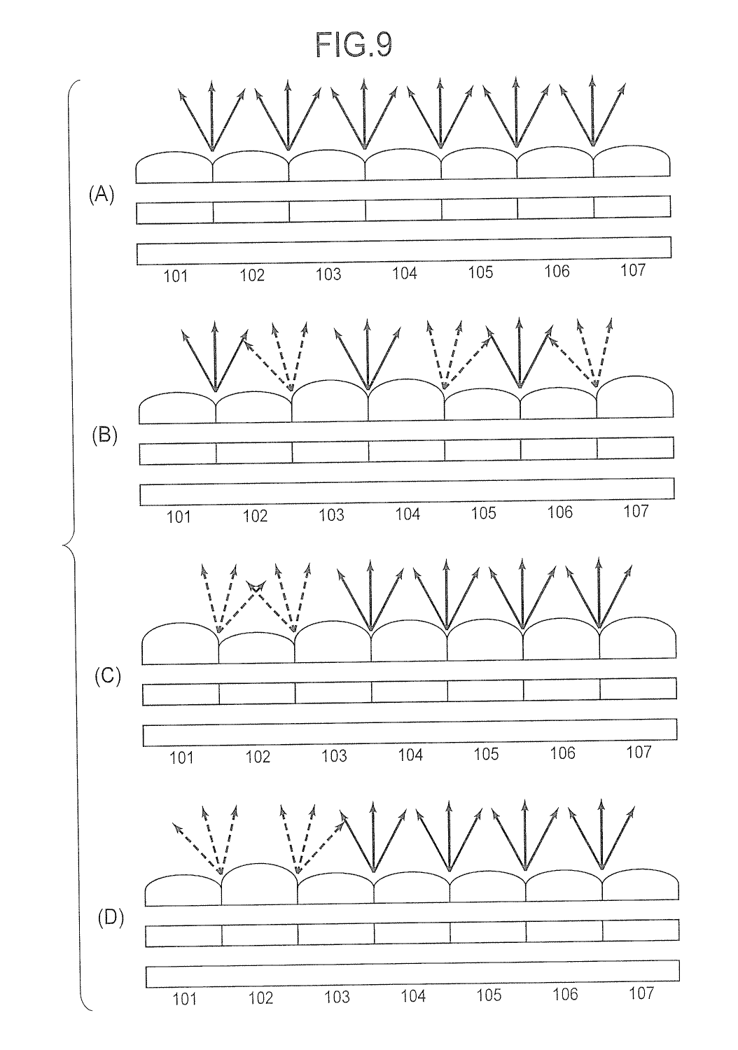

Next, the arrangement of a micro lens with thickness that varies among pixels is explained below using FIG. 9. FIG. 9 shows the direction of diffraction light that has been generated between two neighboring pixels.

First, the relationship between the effect of lowering the contrast and the arrangement of pixels having an e-r-difference with respect to a typical pixel is explained. Only the arrangement of pixels having an e-r-difference is explained below, but the arrangement of pixels having an i-r-difference is similar to that of the e-r-difference.

As shown in FIG. 9 A, when the external OPLs of the first to seventh pixels 101-107 are all equal, the phase of the reflected light at any pair of neighboring pixels is equal. Accordingly, the diffraction light that travels in the same direction (see solid line) is generated between two neighboring pixels, such as the first and second pixels 101, 102, and the second and third pixels 102, 103. The polka-dot pattern with high contrast is generated because the diffraction light forms bright dots by concentrating the diffraction light on the same area of the image sensor.

As shown in FIG. 9B, when pairs of neighboring pixels having the same external reflected OPL and evenly distributed between other pairs of neighboring pixels having the e-r-difference by alternating the pixels having the different external reflected OPL, the direction of the diffraction light generated between the first and second pixels 101, 102 of the pair that has the same external reflected light is different from that generated between the second and third pixels 102, 103 of the pair that has the e-r-difference. In this case, part of the diffraction light reaches an area that the other part of the diffraction light does not reach. Accordingly, the contrast of the diffraction light is minimized.

However, as shown in FIGS. 9C and 9D, when too many or too few pixels have longer external OPLs, the contrast cannot be sufficiently reduced because the part of diffraction light (see dashed line) that reaches an area not reached by the other part of the diffraction light (see solid line) is less than the other part of the diffraction light.

Accordingly, it is necessary to vary the direction of the diffraction light by arranging pixels so that part of the pairs of pixels has the e-r-difference. In addition, it is particularly desirable that half of all of the pairs of pixels have an e-r-difference.

For example, a diffraction angle of one-half is obtained by equally mixing the integer-degree diffraction light with the half-degree diffraction light. The arrangement of pixels with shorter and longer external OPLs that results in a diffraction angle of one-half is explained below. The pixels with shorter and longer external OPLs are hereinafter referred to as normal pixels and lengthened pixels.

If the ratios of the normal pixels and lengthened pixels among all pixels are P and (1−P), respectively, the probability that the neighboring pixels will have a different external OPL is 2×P×(1−P). Accordingly, the probability is 0.5 when P is 0.5. Consequently, it is particularly desirable that the number of lengthened pixels is the same as the number of normal pixels.

In the first embodiment, areas of irregularity, in which a plurality of the lengthened pixels and normal pixels are arranged irregularly, are formed on the image sensor 10. In other words, the lengthened pixels and the normal pixels are dispersed throughout the area of irregularity. In the first embodiment, a plurality of pixel-units is arranged as the areas of irregularity so that the pixel-units are next to each other.

As will be explained later, the size of the pixel-unit is determined to be four times as broad as that of a first area (target zone). The first area is an area of predetermined size that is located anywhere on the light-receiving area of the image sensor 10.

In the first area, the lengthened pixels are arranged so that 25%-75% of all pixels in the first area are lengthened pixels. When homogeneous light is made incident on the entire first area, the influence of the r-d-ghost image based on the incident light can be sufficiently reduced by arranging the lengthened pixels in the first area as described above. Accordingly, when an optical image that produces the r-d-ghost image is broader than the first image, the influence of the r-d-ghost image can be reduced.

In general, when an optical image of the sun having strong light is made incident on the image sensor, the influence of the r-d-ghost image is increased substantially. Accordingly, it is desirable to reduce the contrast of the diffraction light generated at an area where an optical image of the sun is made incident. Consequently, it is desirable to have the lengthened pixels and the normal pixels arranged in a certain area where the optical image of the sun is formed.

As long as the size of the first area is predetermined to be the minimum size of an optical image of the sun that can be formed on the light-receiving area, the influence of the r-d-ghost image can be reduced even if a larger size of an optical image of the sun is formed on the light-receiving area.

The size of the optical image of the sun formed on the light-receiving area varies according to the focal length of an imaging optical system. The size of the optical image of the sun formed on the light-receiving area becomes the minimum when an imaging optical system having the relatively longest focal length is selected for use among the imaging optical systems that are appropriate for use. Accordingly, the size of the first area is predetermined to be the size of an optical image of the sun formed on the light-receiving area when the imaging optical system has the longest focal length.

In other words, the size of an optical image of the sun becomes the minimum when an imaging optical system having the maximum horizontal angle of view is used among the imaging optical systems that are appropriate for use for a digital camera. For example, the horizontal angle of view of a super wide-angle lens in general use is about 100 degrees.

The angle between imaginary lines from the ground to both ends of the horizontal diameter of the sun is about 0.53 degree. Supposing that the number of pixels in one horizontal row is M, the diameter of the optical image of the sun formed on the image sensor 10 is equal to the length of M×0.0053 (=M×0.53 degree/100 degree) pixels.

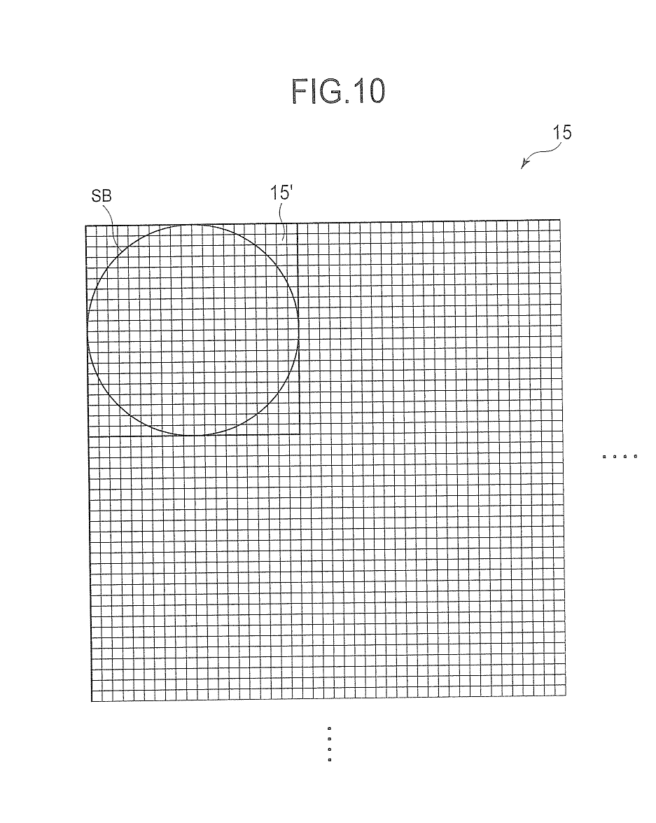

For example, as shown in FIG. 10, when the number of pixels in one horizontal row is 3800, the diameter of the optical image of the sun (see “SB”) is the length of twenty pixels. Accordingly in this case, in a certain first area 15′ (see thick line) that is either square or rectangular-shaped with pixels arranged in twenty rows and twenty columns, the lengthened pixels are arranged so that 25%-75% of all the pixels in the first area are lengthened pixels. The first area 15′ includes 400 pixels (=(M×0.0053)̂2).

In the pixel-unit 15, the lengthened pixels and the normal pixels are arranged so that the ratio of the lengthened pixels is within the 25%-75% range for any area with pixels arranged in twenty rows and twenty columns that is selected as the first area 15′. As described above, by arranging the pixel-units 15 successively so that the pixel-units are located next to each other, the areas of irregularity are formed.

If the size of the pixel-unit 15 is too small, diffraction pattern caused by a cycle of successively arranged pixel-units 15 will appears. Accordingly, it is desirable that the pixel-unit 15 have rows and columns that are twice as long as those of the first area 15′. In this case, the sized of the pixel-unit 15 is greater than or equal to four times the breadth of the first area 15′ and includes a number of pixels that is greater than or equal to 1600 (=(M×0.011)̂2).

On the other hand, if relatively small pixel-units 15 are successively arranged, the effect described below is achieved. Even if the size of the optical image of the sun is smaller than that shown in FIG. 10, the lengthened pixels and the normal pixels can be arranged in an area on which the optical image of the sun is formed. Accordingly, even if the optical image of the sun is too small, a sufficient reduction in the contrast of the r-d-ghost image can be achieved using the small pixel-unit 15. In addition, the number of pixels in the rows may be different from that the number of pixels in the columns of the pixel-unit 15.

It is preferable that the pixel-units 15 are formed on the entire light-receiving area of the image sensor 10. However, only pixels having the same external OPL may be formed around the frame of the light-receiving area; the pixel-units 15 may not be formed in this particular area.

In addition, the area of irregularity is formed on the entire light-receiving area of the image sensor 10 without a repetitive arrangement of the pixel-units 15. In this case, all pixels on the entire light-receiving area are arranged irregularly. Consequently, the appearance of a diffraction pattern caused by a cycle of successively arranged pixel-units 15 can be prevented.

In addition, the area of irregularity may be formed around the center of the light-receiving area by arranging many pixels irregularly, and the pixels having the same external OPL may be arranged around the frame of the light-receiving area. In other words, only a single pixel-unit 15 is formed.

In addition, pixels having two different external OPLs are arranged in either the pixel-unit 15 or the area of irregularity. Pixels with three or more different external OPLs can also be arranged.

In addition, the first area 15′ can be broader than that described above by considering the circle of confusion of the optical image of the sun. The size of the circle of confusion for a general digital camera is about 1/1000 of the horizontal length of the image sensor 10. Accordingly, for the image sensor where the number of pixels in one horizontal row is 3800, the first area 15′ should be enlarged by about four pixels.

In this case, the coefficient in the above equation for the number of pixels included in the rows and columns of one first area 15′ is compensated by 1/1000 for the size of the circle of confusion. So, the number of pixels included in the rows and columns of one first area is calculated by (M×0.0053) (=(M×(0.0053+ 1/1000))). When the number of pixels in one horizontal row is 3800, the number calculated for the first area 15′ is about 24. So, the first area 15′ has 24 pixels in its rows and columns. In such a first area 15′, the lengthened pixels and the normal pixels are arranged so that 25%-75% of all pixels in the first area 15′ are lengthened pixels.

The first area 15′, which has 24 or more pixels in its rows and columns and corresponds to the spot diameter of the optical image of the sun including the circle of confusion, has 576 or more pixels.

It is desirable for the pixel-units 15 to have 48 (M×0.012) or more pixels in its rows and columns if the first area 15′ has 24 or more pixels in its rows and columns.

The first area 15′ may also have 10 or 12 pixels in its rows and columns, which are half of 20 and 24 and are calculated by (M×0.0027) and (M×0.0032), respectively. In this case, the first area 15′ has about 100 or 140 pixels.

The arrangement of the lengthened pixels and the normal pixels are determined by a method of trial and error using a computer so that the ratio of the lengthened pixels to all pixels is in the 25%-75% range for the first area 15′ that is selected in the pixel-unit 15.

In the above first embodiment, the contrast of the diffraction light can be reduced by arranging the lengthened pixels and the normal pixels irregularly. Accordingly, the influence of the r-d-ghost image, which cannot be prevented from appearing by fine convex and concave surfaces on the micro lens, can be effectively mitigated.

In addition, by using the trial and error method the arrangement of the pixels can be determined quickly and easily so as to satisfy the condition described above.

In addition, in the above first embodiment the micro-lens array 16 having various thickness can be manufactured more easily than a micro lens with fine dimpled surfaces. Therefore, the image sensor 10 can be manufactured more easily.

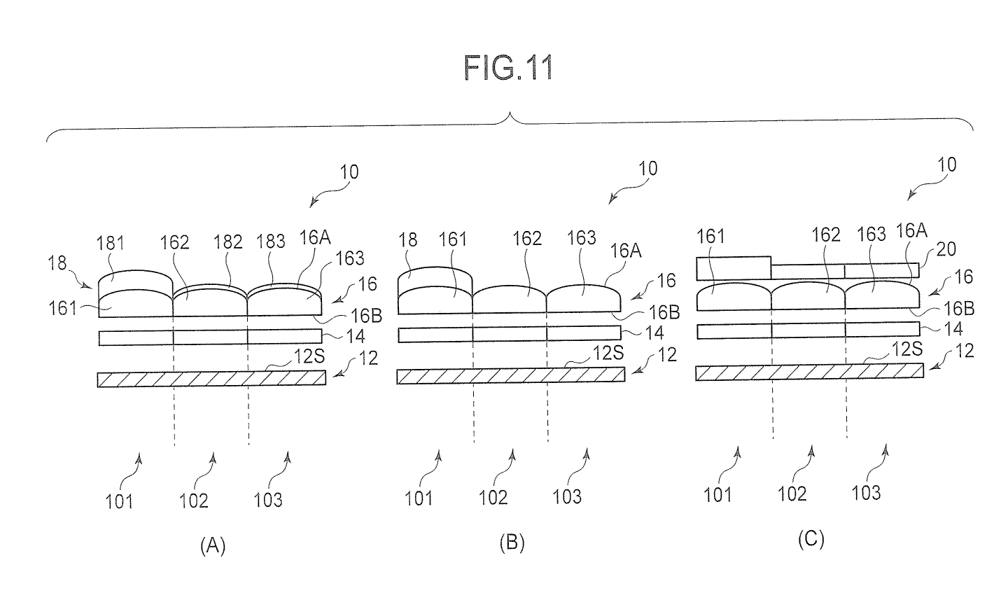

Next, an image sensor of the second embodiment is explained. FIG. 11 is a sectional view of the image sensor of the second embodiment.

The primary difference between the second embodiment and the first embodiment is the method for calculating the e-r-difference between a pair of pixels. The second embodiment is explained mainly with reference to the structures that differ from those of the first embodiment. Here, the same index numbers are used for the structures that correspond to those of the first embodiment.

In the second embodiment, the thickness of the micro lenses is constant. So, there is no difference between the distance from the light-receiving area of the photoelectric conversion layer 12 to the external or internal surface 16A, 16B of the micro-lens array 16. Optical elements that cause the external OPL to vary for each pixel are mounted above the external surface 16A of the micro-lens array 16.

For example, as shown in FIG. 11A, a permeable film 18 is coated on the micro-lens array 16. The film 18 is formed so that the thickness varies across each of the pixels, such as the first-third area 181-183 corresponding to the first-third pixels 101-103. In addition, the film 18 is coated so that the film makes contact with the micro-lens array 16. The e-r-difference between pairs of pixels can be produced by adding the film 18. In this case, the incident end of the incident light is the external surface of the film 18.

Further, as shown in FIG. 11B, the e-r-difference between pairs of pixels may be created by alternating pixels that have the film 18 with pixels that do not have the film 18. Moreover, the optical elements that cause the external OPL to change for each of the pixels are not limited to the film 18. As shown in FIG. 11C, a plate 20 made from resin or glass with varying thickness across each of the pixels can be used. In the above second embodiments, the effect of lowering the influence of the r-d-ghost image can be achieved by adding the above optical elements to general image sensors that are already in use or that have already been manufactured but are not yet in use.

In the above second embodiment, the contrast of the diffraction light can be reduced by arranging the lengthened pixels and the normal pixels irregularly. Accordingly, the appearance of the r-d-ghost image, which cannot be prevented by fine convex and concave surfaces on the micro lens, can be effectively mitigated.

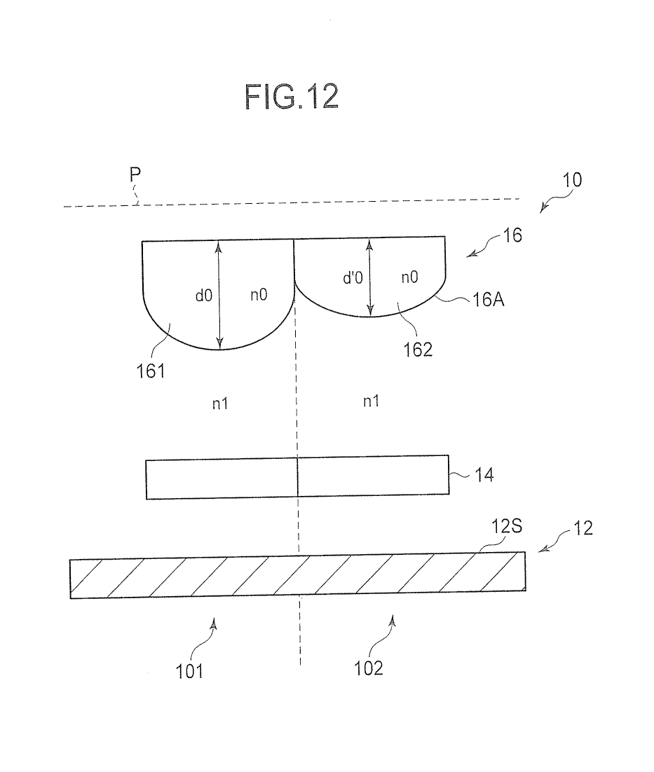

Next, an image sensor of the third embodiment is explained. The primary difference between the third embodiment and the first embodiment is the structure of the micro-lens array. The third embodiment is explained mainly with reference to the structures that differ from those of the first embodiment. Here, the same index numbers are used for the structures that correspond to those of the first embodiment. FIG. 12 is a sectional view of the image sensor of the third embodiment.

In the third embodiment, the micro-lens array 16 is mounted so that the external surface 16A of the micro-lens array 16 in the first embodiment faces the light-receiving area of the photoelectric conversion layer 12. In other words, the micro-lens array 16 in the first embodiment is inverted in the third embodiment. Accordingly, in the third embodiment, the entire external surface of the micro-lens array is a flat plane. Convex surfaces that work as micro lenses are mounted on the internal surface of the micro lens array 16.

Because the external surface of the micro-lens array 16 in the third embodiment is entirely flat, the diffraction light is not generated by reflection of light at the external surface. Accordingly, the diffraction light based on reflection is generated only at the internal surface. As described above, the i-r-difference is calculated as (d0−d′0)×n1×2 (n1 being the refractive index of the micro-lens array). In addition, the i-r-difference, which mitigates the influence of the i-d-ghost image, is (m+½)×λ (m being an integer). Accordingly, the difference between the thicknesses of micro lenses in a pair of pixels that is necessary to produce a phase difference is calculated as (m+½)×λ/((the refractive index of the micro lens)×2).

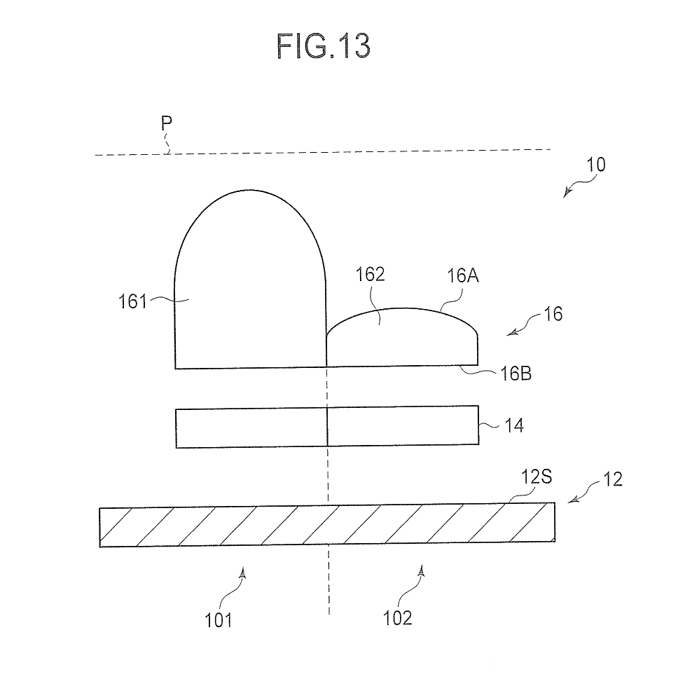

Next, an image sensor of the fourth embodiment is explained. The primary difference between the fourth embodiment and the first embodiment is the structure of the micro-lens array. The fourth embodiment is explained mainly with reference to the structures that differ from those of the first embodiment. Here, the same index numbers are used for the structures that correspond to those of the first embodiment. FIG. 13 is a sectional view of the image sensor of the fourth embodiment.

In the fourth embodiment, the micro-lens array is formed in consideration of the diffraction light derived not only from reflection at the external surface but also from reflection at the internal surface. In other words, the micro-lens array is formed so that the e-r-difference and the i-r-difference are (m+½)×λ.

Similar to the first embodiment, the e-r-difference is (d′0−d0)×n0×2. Using the equation of d1+d0=d′1+d′0, the e-r-difference is (d1−d′1)×n0×2. Accordingly, the difference in thickness between pairs of adjacent micro lenses (d1−d′1) is calculated as (m1+½)×λ/(n0×2) (m1 being an integer) so that the phase difference of the light reflected at the external surfaces between the pixels having the micro lenses is one-half of the wavelength.

Similar to the first embodiment, the i-r-difference is (d1−d′1)×(n1−n0)×2. Accordingly, the difference in thickness between pairs of adjacent micro lenses (d1−d′1) is calculated as (m2+½)×λ/((n1−n0)×2) (m2 being an integer) so that the phase difference of the light reflected at the internal surfaces between the pixels having the micro lenses is one-half of the wavelength.

Accordingly, in order to shift the phase of the light reflected at external and internal surfaces between the pixels by one-half wavelength, the micro-lens array should be formed so that the difference in thickness between the pairs of micro lenses (d1−d′1) is equal to both (m1+½)×λ/(n0×2) and (m2+½)×λ/((n1−n0)×2).

In order to satisfy the above condition, the refractive index of the micro-lens array should satisfy the equation (m1+½)×λ/(n0×2)=(m2+½)×λ/((n1−n0)×2). For example, assuming that m1 and m2 are 1 and 0, respectively, the refractive index of the micro-lens array is calculated to be 1.33.

By making the micro-lens array 16 from a substance of which the refractive index is 1.33 so that the i-r-difference is λ/2, the difference between the thickness of the micro lenses becomes ( 3/2))<λ/2. Then, the e-r-difference is ( 3/2)×λ. Using the micro-lens array, phase differences of light reflected between the external and internal surfaces of micro lenses can be one-half of the wavelength. In order to achieve this effect, the desired refractive index of the micro-lens array is 1.33. However, the refractive index can be less than or equal to 1.4 or greater than or equal to 1.66.

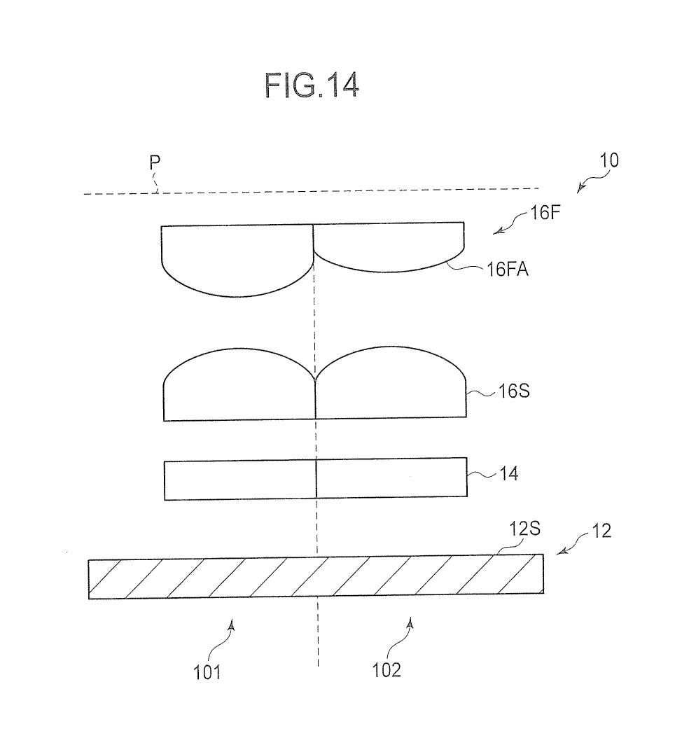

Next, an image sensor of the fifth embodiment is explained. The primary difference between the fifth embodiment and the first embodiment is the number of the micro-lens array mounted on the image sensor. The fifth embodiment is explained mainly with reference to the structures that differ from those of the first embodiment. Here, the same index numbers are used for the structures that correspond to those of the first embodiment. FIG. 14 is a sectional view of the image sensor of the fifth embodiment.

In the fifth embodiment, a lens array system is composed of a plurality of micro-lens arrays, which are first and second micro lens arrays 16F, 16S. The first micro lens array 16F is mounted further from the photoelectric conversion layer 12 than the second micro lens array 16S. One surface of the first micro-lens array 16F has differences in height between pixels, and the other surface is flat. The first micro-lens array 16F is configured so that the surface 16FA having a difference in height is an internal surface that faces the light-receiving area of the photoelectric conversion layer 12, so that the flat surface is the external surface.

For the first micro-lens array 16F, the difference in thickness between pixels can be created similar to the third embodiment. Accordingly, the i-r-difference between pixels in the fifth embodiment is the same as that of the third embodiment.

Accordingly, the difference in thickness between pixels of the first micro-lens array 16F should be (m+½)×λ/((refraction index f of the micro-lens array)×2). For example, assuming that m and the refraction index are 1 and 1.5, respectively, the difference in thickness is calculated to be λ/2 (=(1+½)×λ/(1.5×2)).

The e-r-difference and i-r-difference for the reflection of the light at the external and internal surfaces of the second micro-lens array 16S are calculated to be λ/2 (=(difference in thickness between pixels of first micro-lens array 16F)×((refraction index of first micro-lens array 16F)−(refraction index of air))×2). Accordingly, the influence of diffraction light generated from the reflection of light at the external and internal surfaces of the second micro-lens array 16S can be mitigated.

Similar to the reflection at the second micro-lens array 16S, the influence of diffraction light generated from the reflection at other components, such as the color filter layer 14 and the photoelectric conversion layer 12, which are mounted inside the first micro-lens array 16F, can also be mitigated.

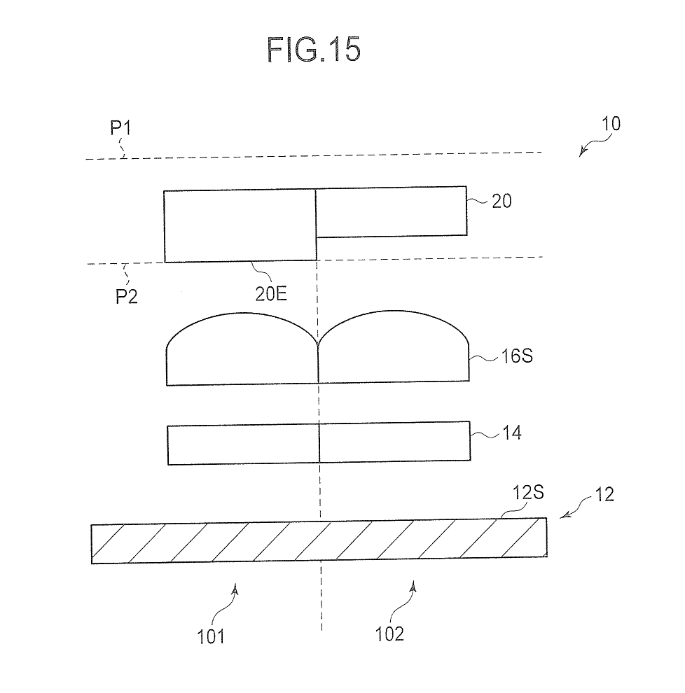

As shown in FIG. 15, instead of the first micro-lens array 16F, a phase plate 20 can be adopted so that the convex and concave surfaces face the light-receiving area of the photoelectric conversion layer 12. Or, the curvature of the micro lenses of the first micro-lens array 16F can be zero.

By cyclically creating the difference in the thickness between pixel areas of the phase plate 20, the e-r-difference and i-r-difference can be created. In addition, by making both surfaces of the phase plate 20 flat, the appearance of the r-d-ghost image generated by the reflection at the external and internal surfaces of the phase plate 20 can be prevented. In addition, it is preferable to reduce the reflectivity of the phase plate 20 by coating it with an agent.

The imagined plane described in the first embodiment is defined here as a first imagined plane (see “P1”). In addition, a plane that is parallel to the first imagined plane and a convex portion 20E of the internal surface of the phase plate 20 is defined as a second imagined plane (see “P2”.

When using the phase plate 20, the difference in OPLs from the first imagined plane to the external surface of the pixel's micro lenses and the difference in OPLs from the first imagined plane to the internal surface of the pixels' micro lenses are equal to the difference in the OPLs from the first imagined plane to the second imagined plane for pixels.

In addition, by cyclically creating the difference in the thickness between pixel areas of the phase plate 20, the difference in OPLs from the first imagined plane to any components mounted beneath the phase plate, such as the photoelectric converter layer 12, can also be created. The difference in the OPLs is equal to the difference in the OPLs from the first imagined plane to the second imagined plane for pixels, similar to the above.

In the above first and second embodiments, the influence of the r-d-ghost image generated by the reflection not only at the external surface but also at the internal surface can be reduced. By creating the difference in the distances from the photoelectric converter layer 12 to the internal surface 16B of the micro-lens array between pixels, the i-r-difference is created. Then, the r-d-ghost image generated by the reflection at the internal surface 16B can be reduced.

Whether the ghost image is generated from the light reflected at both surfaces of the micro-lens array 16 or from the light reflected at the components inside of the micro-lens array 16, such as the photoelectric conversion layer 12 and the layer of electrical wiring (not depicted), its influence can be mitigated by varying the thickness of the micro lens between pixels.

Hereinafter, an integral value of the distances of substances and spaces multiplied by the corresponding refractive indexes of the substances and spaces between the component inside of the micro-lens array 16 and the imagined plane is defined as an inside OPL. In addition, an optical path length of light that travels from the imagined plane to the component inside the micro-lens array 16 and is reflected by the component back to the imagined plane is defined as an inside reflected OPL. Pairs of pixels having equal inside OPLs and unequal inside OPLs are arranged similar to the above embodiments.

However, different from the above embodiments, the influence of the ghost image generated from the reflected light of each color that passes through the color filter of the color filter layer 14 should be reduced. Accordingly, it is preferable to determine the differences between inside OPLs for pairs of pixels individually based on the wavelength of each color and the distance between the pixels of each color for the r-pixels, g-pixels, and b-pixels.

In order to mitigate the influence of the ghost image generated from the light reflected at the external and internal surfaces 16A, 16B of the micro-lens array 16, as described above, it is sufficient to arrange the lengthened pixels and the normal pixels in the pixel-unit 15 independent of pixel color.

On the other hand, in the case of adding the difference of the inside OPL, it is preferred that the lengthened pixels and normal pixels that have red color filters are arranged in the pixel-unit 15 so that the above condition is satisfied. In addition, it is preferred that the lengthened pixels and normal pixels that have green color filters are arranged in the pixel-unit 15 so that the above condition is satisfied. Further, it is preferred that the lengthened pixels and normal pixels that have blue color filters are arranged in the pixel-unit 15 so that the above condition is satisfied.

As described above, by creating the e-r-difference between two pixels, phase differences can be produced in the light reflected not only at the external surface of the micro lenses but also at the internal surface and at a component inside the micro-lens array 16. Accordingly, by creating the e-r-difference that is sufficient for reducing the r-d-ghost image generated by reflecting at the external surface 16A, the influence of the ghost image created from the light reflected at the internal surface and the component inside the micro-lens array 16 can still be mitigated even if the i-r-difference and the difference of the inside reflected OPL are not optimal with respect to reducing the influence against the reflection at the internal surface 16B and internal component.

In addition, the structure of the image sensor 10 is not limited to those in the above embodiments. For example, a monochrome image sensor can be adopted for the above embodiments.

In addition, for an image sensor of which color filters are arranged according to any color array except for the Bayer color array, the lengthened pixels and the normal pixels can be mixed and arranged irregularly.

In addition, for an image sensor where photoelectric converters that detect quantities of light having different wavelength bands, such as red, green, and blue light, are layered at all the pixels, the lengthened pixels and the normal pixels can be mixed and arranged similar to the above embodiments. Because it is common for the diffraction angle in such an image sensor to be greater than that for other types of image sensors, image quality can be greatly improved by mixing the arrangement of the lengthened pixels and normal pixels.

In this case, it is preferable that the e-r-difference, i-r-difference or difference of the inside reflected OPL is determined according to the wavelength of whichever light can be detected by the photoelectric converter mounted at the deepest point from the incident end of the image sensor, such as the wavelength of red light. A light component that is reflected at the two photoelectric converters above the deepest one, which is red light in this case, generates more diffraction light than the other light components that are absorbed by the photoelectric converters above the deepest one.

In addition, the same effect can be achieved by attaching a micro-lens array having micro lenses of various thickness to the image sensor module, which does not have a micro-lens array having micro lenses of various thickness, as long as each pixel of the image sensor faces one micro lens. For example, the same effect can be achieved by attaching the micro-lens array to a manufactured image sensor. Similar to a micro-lens array, the same effect can be achieved by attaching a glass cover or optical low-pass filter of which thickness is different for each of the pixels.

The e-r-difference, i-r-difference, or difference of the inside reflected OPL is desired to be (m+½)×λ(m being an integer and λ being the wavelength of incident light) for the simplest pixel design. However, their differences are not limited to (m+½)×λ.

For example, the length added to the wavelength multiplied by an integer is not limited to half of the wavelength. One-half of the wavelength multiplied by a coefficient between 0.5 and 1.5 can be added to the product of the wavelength and an integer. Accordingly, the micro lens array can be formed so that the e-r-difference, i-r-difference, or difference of the inside reflected OPL is between (m+¼)×λ and (m+¾)×λ.

In addition, the micro-lens array can be formed so that the e-r-difference, i-r-difference, or difference of the inside reflected OPL is (m+½)×λb (where λb is between 0.5λc<λb<1.5λc and λc is a middle wavelength value of a band of light that reaches the photoelectric converter).

In addition, the micro-lens array can be formed so that the e-r-difference, i-r-difference, or difference of the inside reflected OPL is (m+½)×λb (where λb is between 0.5λe<λb<1.5λe and λe is a middle wavelength value of a band of light that passes through each of the color filters).

The wavelength band of the incident light that reaches the photoelectric conversion layer 12 includes visible light. Accordingly, assuming that λg is a wavelength near to the middle wavelength in the band of visible light, the e-r-difference, which is equal to the difference in the of thickness of the micro lens, is desired to be (m+½)×λg. For example, the e-r-difference is desired to be within 200 nm-350 nm, especially within 250 nm-300 nm. Instead of using λg, the wavelength near the middle wavelength for the band of each color of light that passes through each color filter can be used for the above calculation.

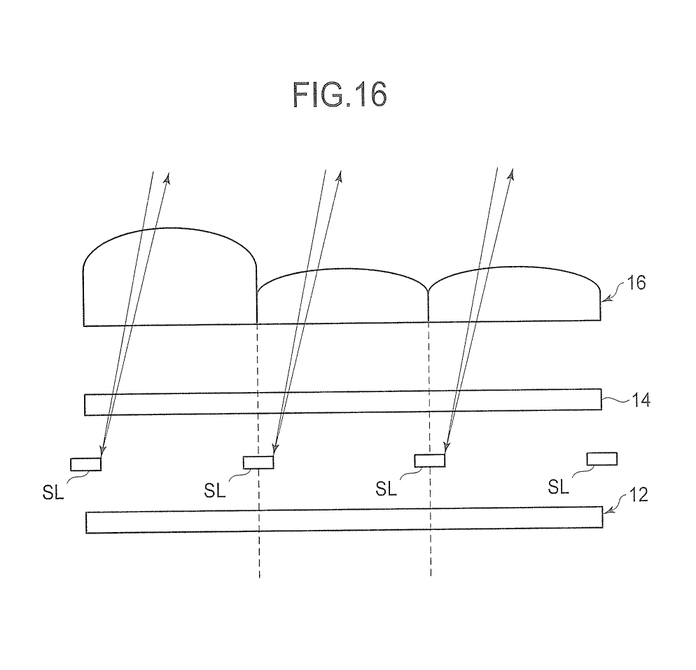

In addition, as shown in FIG. 16, the r-d-ghost image may be generated on the basis of the reflection of light at the layer of electrical wiring (see “SL”) in the image sensor 10. In order to reduce the influence of the r-d-ghost image, the difference in optical path length from the imagined plane to the layer of wiring between pairs of pixels is preferred to be (m+½)×λ/2. Because the difference in optical path length from the imagined plane to the layer of wiring between pairs of pixels is equal to the difference of the inside reflected OPL, the influence of the r-d-ghost image created from the light reflected not only at the light-receiving area of the photoelectric conversion layer 12 but also at the layer of wiring can be reduced when the difference of the inside reflected OPL is (m+½)×λ.

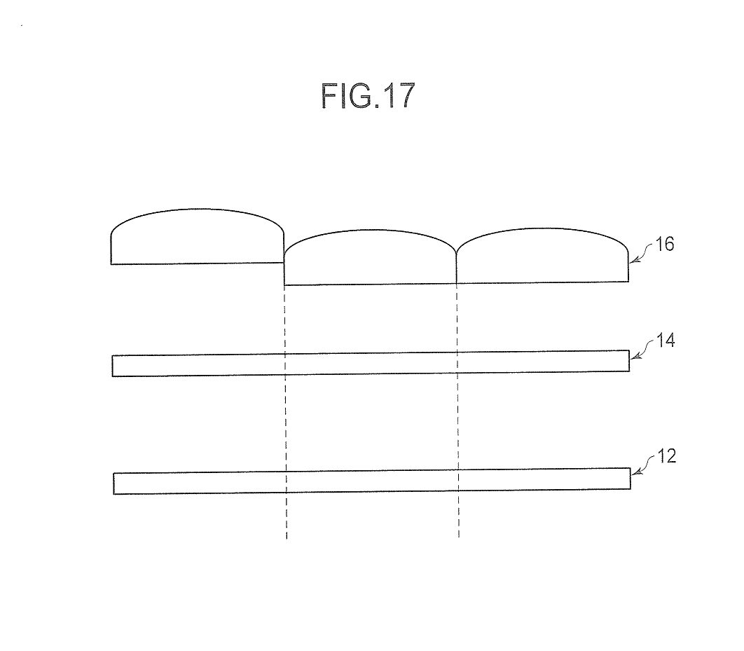

The external OPL is modified by changing the thickness of the micro lenses for the pixels in the first and second embodiments. However, as shown in FIG. 17, even if the thickness of the micro lens is not changed, the external OPL and the distance from the photoelectric conversion layer 12 to the top of the micro lens array 16 can be modified.

### EXAMPLES

Next, this embodiment is explained with regard to the concrete arrangement of the lengthened pixels and the normal pixels and the effect below with reference to following examples. However, this embodiment is not limited to these examples.

### Example 1

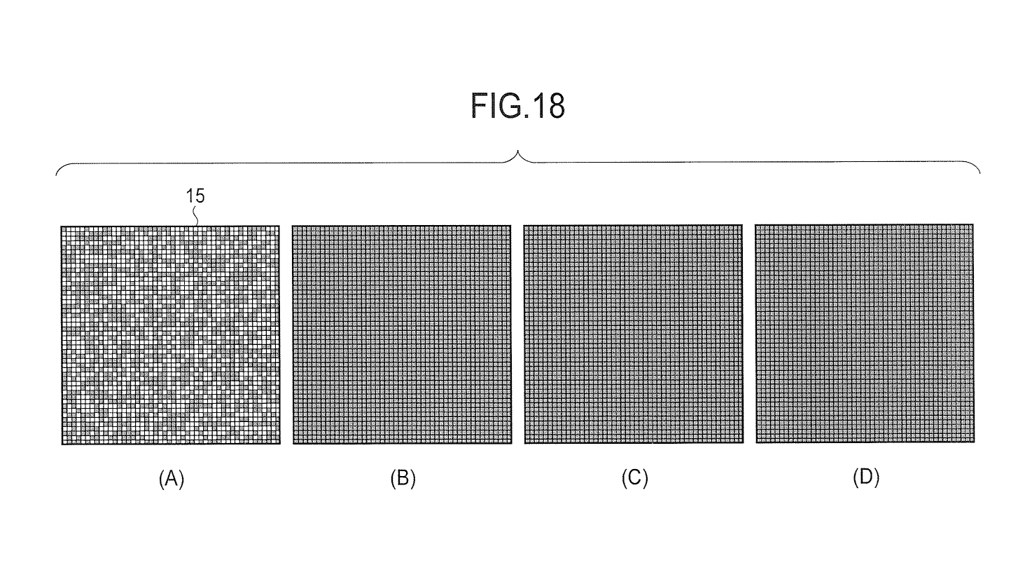

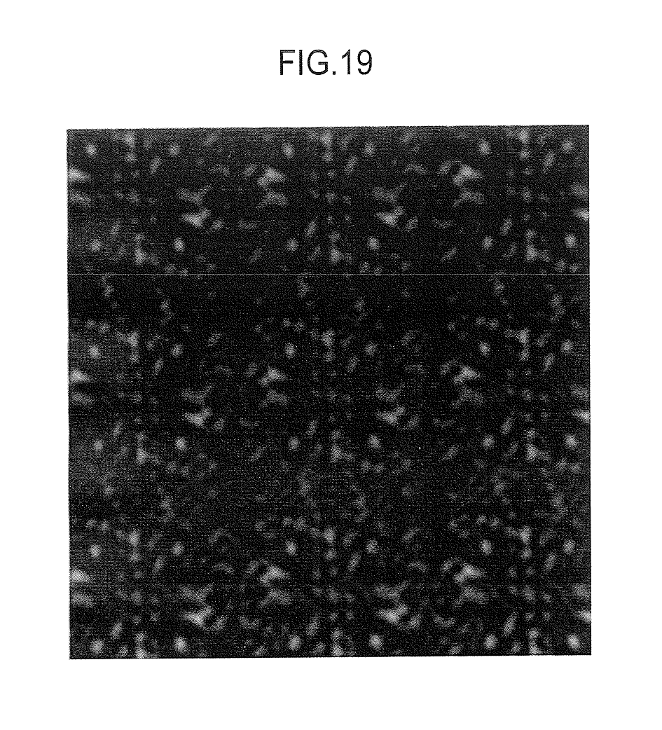

FIG. 18A is a deployment diagram showing the arrangement of the lengthened pixel in the pixel-unit of the first example. FIGS. 18B to 18D show whether or not the ratio of lengthened pixels to all pixels in the first area is between 25%-75%. FIG. 19 shows the contrast of the diffraction light of the first example.

As shown in FIG. 18A, pixels are arranged irregularly in 48 rows and columns in the pixel-unit 15 of the first example. The pixel-unit of the first example is four times as broad as that of an optical image of the sun including the circle of confusion.

In FIG. 18A, the lengthened pixels are shaded and the normal pixels are white. The colors of the lengthened pixels and the normal pixels in the other examples and in the comparative example are the same as those in FIG. 18A.

In the first example, the lengthened pixels are arranged so that half of all pixels in the pixel-unit 15 are lengthened pixels. Accordingly, the number of lengthened pixels is the same as the number of normal pixels in the pixel-unit 15, which is the area of irregularity.

In the first example, the determination of whether or not the pixel-unit 15 satisfies conditions 1-3 is described below. In the other examples and in the comparative example the determination is made in the same manner.

Under condition 1, any area having pixels arranged in 24 rows and columns are designated as a first area 15′. Also under condition 1, the ratio of lengthened pixels to all pixels in the first area 15′ is between 25% and 75%. Whether the first example satisfies condition 1 is determined.

The determination of whether the first example satisfies condition 1 is shown in FIG. 18B. In FIG. 18B, a pixel that is located at the center of a first area 15′, which satisfies condition 1, is shaded. On the other hand, a pixel that is located at the center of a first area 15′ but does not satisfy condition 1 is white. The colors indicating whether the first area 15′ satisfies condition 1 for the other examples and for the comparative example are the same as those in FIG. 18B. As shown in FIG. 18B, all pixels are shaded. Accordingly, it was determined that condition 1 was satisfied for the entire pixel-unit 15, in other words condition 1 was satisfied for all first areas 15′ that have central pixels within the pixel-unit 15.

Under condition 2, any area having pixels arranged in 20 rows and columns is designated as a first area 15′. Also under condition 2, the ratio of lengthened pixels to all pixels in the first area 15′ is between 25% and 75%. Whether the first example satisfies condition 2 is determined.

The determination of whether the first example satisfies condition 2 is shown in FIG. 18C. In FIG. 18C, a pixel that is located at the center of a first area 15′, which satisfies condition 2, is shaded. On the other hand, a pixel that is located at the center of a first area 15′ but does not satisfy condition 2 is white. The colors indicating whether the first area 15′ satisfies condition 2 for the other examples and for the comparative example are the same as those in FIG. 18C. As shown in FIG. 18C, all pixels are shaded. Accordingly, it was determined that condition 2 was satisfied for the entire pixel-unit 15, in other words condition 2 was satisfied for all first areas 15′ with centers having pixels within the pixel-unit 15.

Under condition 3, any area having pixels arranged in 10 rows and columns is designated as a first area 15′. Also under condition 3, the ratio of lengthened pixels to all pixels in the first area 15′ is between 25% and 75%. Whether the first example satisfies condition 3 is determined.

The determination of the first example satisfies condition 3 is shown in FIG. 18D. In FIG. 18D, a pixel that is located at the center of a first area 15′, which satisfies the condition 3, is shaded. On the other hand, a pixel that is located at the center of a first area 15′ but does not satisfy condition 3 is white. The colors indicating whether the first area 15′ satisfies condition 3 for the other examples and for the comparative example are the same as those in FIG. 18D. As shown in FIG. 18D, all pixels are shaded. Accordingly, it was determined that condition 3 was satisfied for the entire pixel-unit 15, in other words condition 3 was satisfied for all first areas 15′ with centers having pixels within the pixel-unit 15.

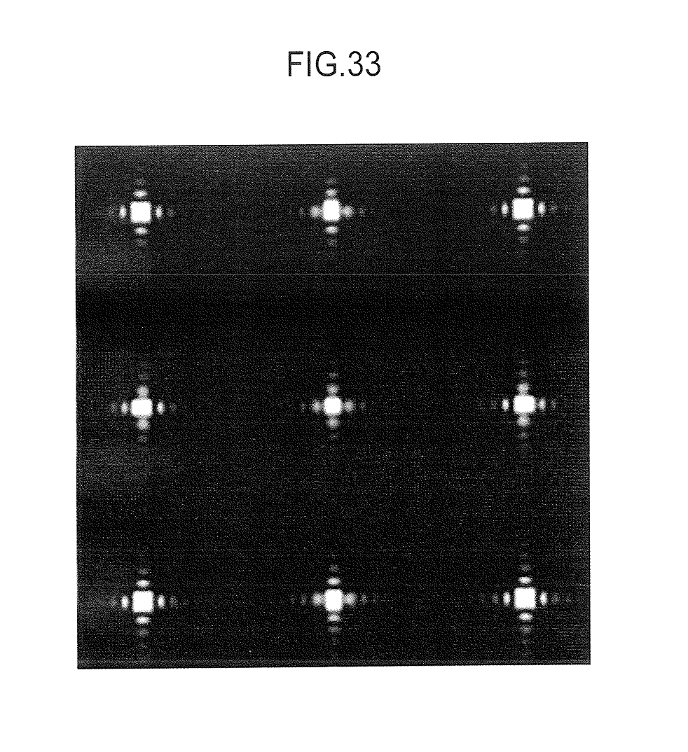

As described above, the image sensor 10 having pixels arranged as shown in FIG. 18A can satisfy conditions 1-3. As shown in FIG. 19, an optical image of diffraction light captured by the image sensor 10 having the first areas 15′ of the first example, which has 50% of the lengthened pixels, is more blurred than that of the comparative example to be described later (see FIG. 33). Accordingly, the contrast of the diffractive light is substantially lower than that of the comparative example.

### Example 2

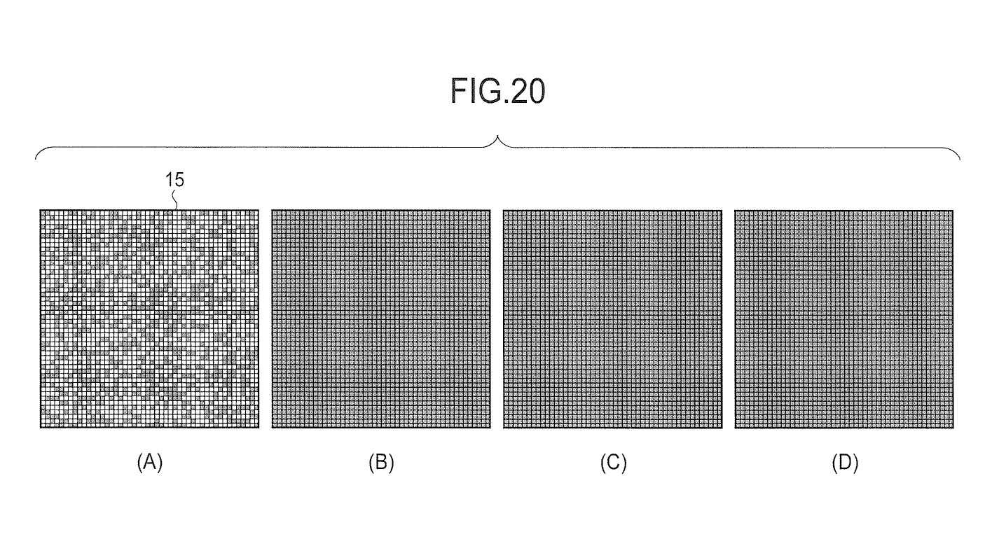

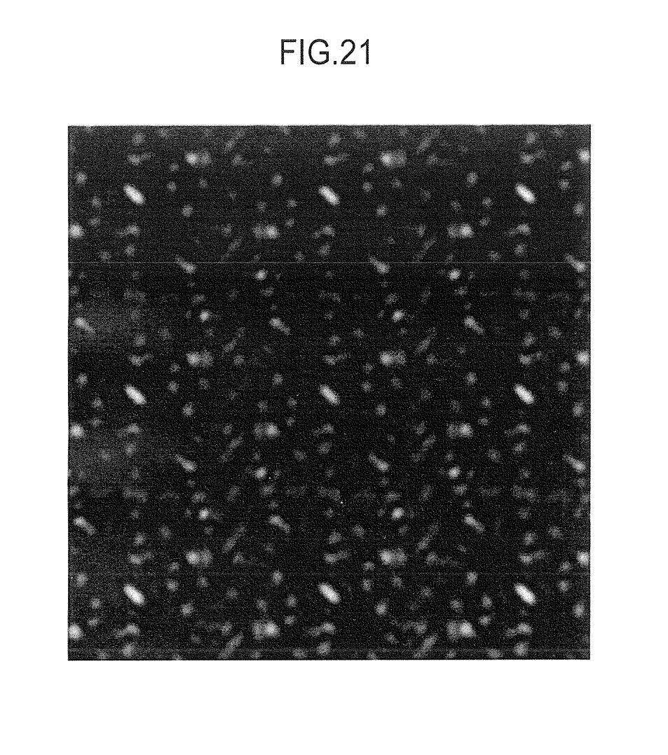

Next, the structure and the effect of the second example are explained below. FIG. 20A is a deployment diagram showing the arrangement of the lengthened pixel in the pixel-unit of the second example. FIGS. 20B to 20D show whether or not the ratio of lengthened pixels to all pixels in the first area is between 25% and 75%. FIG. 21 shows the contrast of the diffraction light of the second example.

As shown in FIG. 20A, pixels are arranged irregularly in 48 rows and columns in pixel-unit 15 of the second example, similar to the first example. In the second example, the lengthened pixels are arranged so that the number of lengthened pixels represents 40% of all pixels in the pixel-unit 15. Accordingly, lengthened pixels account for 40% of all pixels in the pixel-unit 15, which is the area of irregularity.

Similar to the first example, the determination of whether or not pixel-unit 15 in the second example, as shown in FIG. 20A, satisfies conditions 1-3 is described below. The determination of whether the second example satisfies conditions 1-3 is shown in FIGS. 20B to 20D, in which all pixels are shaded. Accordingly, it was determined that conditions 1-3 were satisfied for the entire pixel-unit 15.

As described above, the image sensor 10 having pixels arranged as shown in FIG. 20A can satisfy conditions 1-3. As shown in FIG. 21, an optical image of diffraction light captured by the image sensor 10 having the first areas 15′ of the second example, which has 40% of the lengthened pixels, is more blurred than that of the comparative example to be described later (see FIG. 33). Accordingly, the contrast of the diffraction light is substantially lower than that of the comparative example.

The effect of reducing the contrast of the diffraction light with a pixel-unit 15 that has lengthened pixels representing 60% of its entire area is thought to be the same as that with 40% lengthened pixels as in the second example. So, in the second and other examples, the pixel-units 15 with 50% or fewer lengthened pixels are examined.

### Example 3

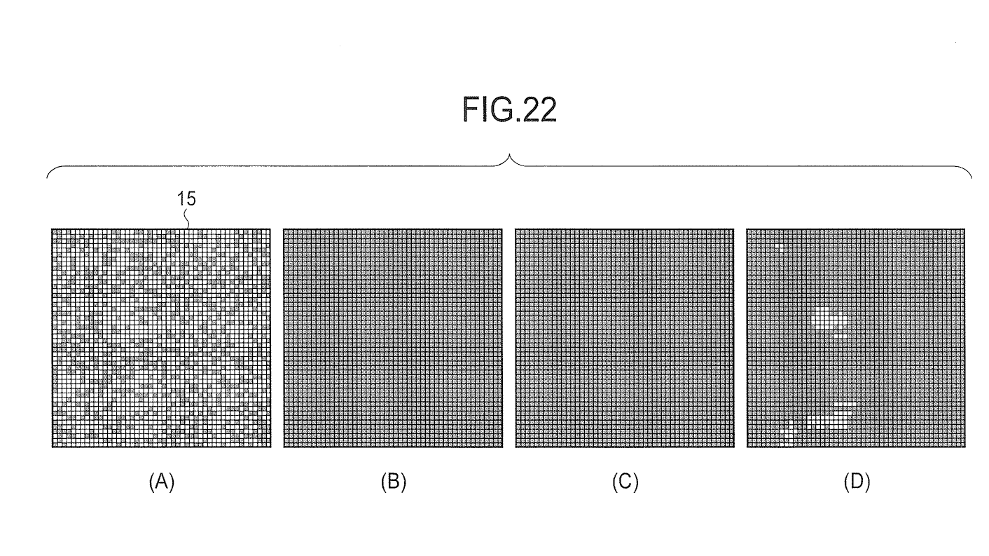

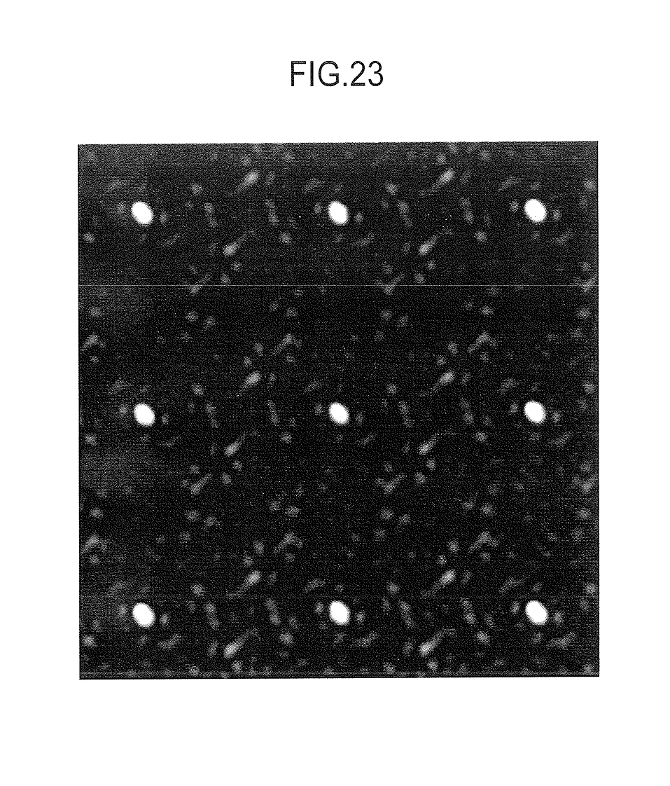

Next, the structure and effects of the third example are explained below. FIG. 22A is a deployment diagram showing the arrangement of the lengthened pixels in the pixel-unit of the third example. FIGS. 22B-22D show whether or not the ratio of lengthened pixels to all pixels in the first area is between 25% and 75%. FIG. 23 shows the contrast of the diffraction light of the third example.

As shown in FIG. 22A, pixels are arranged irregularly in 48 rows and columns in the pixel-unit 15 of the third example, similar to the above examples. In the third example, the lengthened pixels are arranged so that the number of lengthened pixels account for 35% of all pixels in the pixel-unit 15, which is the area of irregularity.

Similar to the first example, the determination of whether or not the pixel-unit 15 in the third example, as shown in FIG. 22A, satisfies conditions 1-3 is described below. The determination of whether the third example satisfies conditions 1-3 is shown in FIGS. 22B to 22D. As shown in FIGS. 22B and 22C, all pixels are shaded. Accordingly, it was determined that conditions 1 and 2 were satisfied for the entire pixel-unit 15.

On the other hand, as shown in FIG. 22D, some of the pixels are white. Accordingly, in the third example condition 3 is not satisfied for first areas 15′ with centers having white pixels.

As described above, 35% of the pixels on the image sensor 10 in the third example are lengthened pixels, and it cannot satisfy condition 3. As shown in FIG. 23, an optical image of diffraction light captured by the image sensor 10 having the first areas 15′ of the third example is greater than the captured optical image of the first and second examples. In addition, the brightness of the optical image of the third example is greater than that of the first and second examples. However, the optical image is more blurred than that of the comparative example to be described later (see FIG. 33). Accordingly, the contrast of the diffraction light is substantially lower than that of the comparative example.

### Example 4

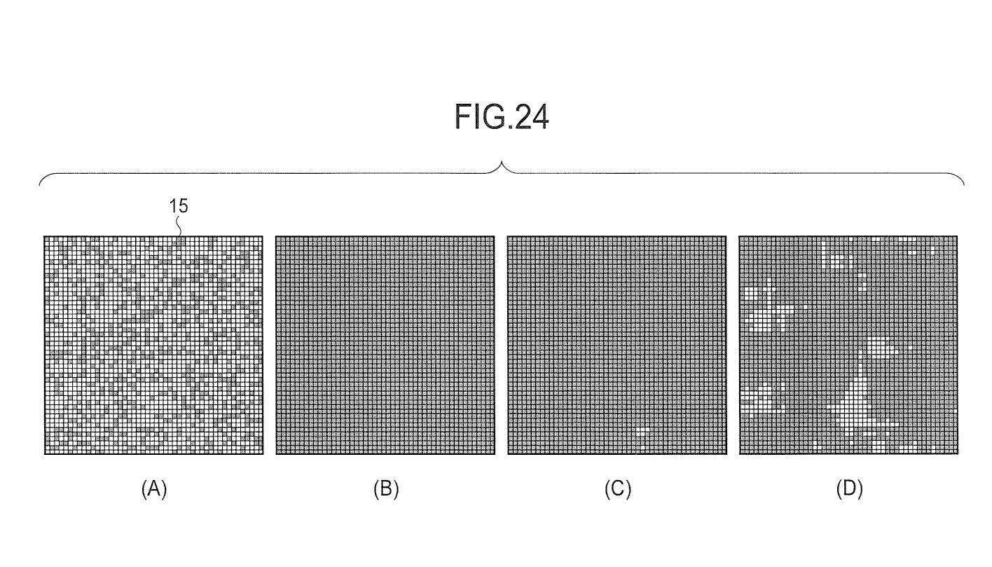

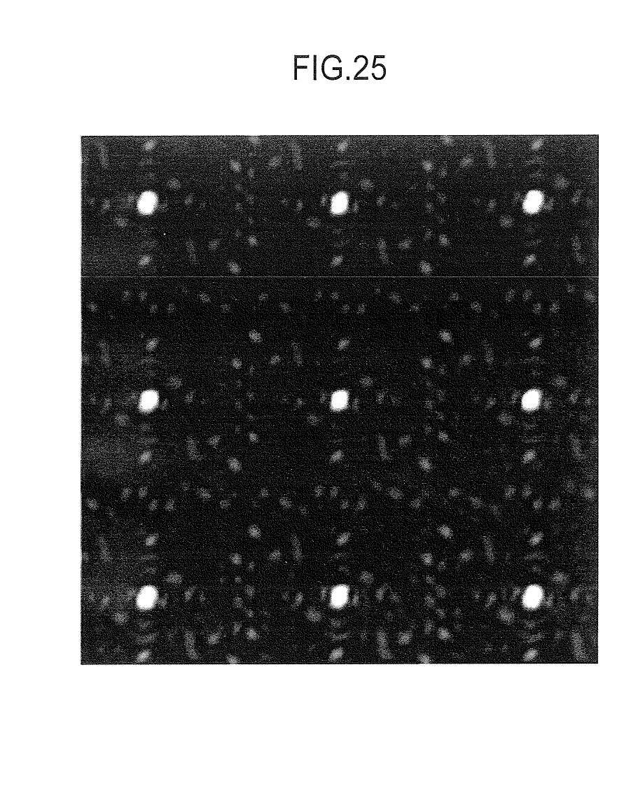

Next, the structure and the effects of the fourth example are explained below. FIG. 24A is a deployment diagram showing the arrangement of the lengthened pixels in the pixel-unit of the fourth example. FIGS. 24B-24D show whether or not the ratio of the lengthened pixels to all pixels in the first area is between 25% and 75%. FIG. 25 shows the contrast of the diffraction light of the fourth example.

As shown in FIG. 24A, pixels are arranged irregularly in 48 rows and columns in the pixel-unit 15 of the fourth example, similar to the above examples. In the fourth example, the lengthened pixels are arranged so that the number of the lengthened pixels account for 30% of all pixels in the pixel-unit 15, which is the area of irregularity.

Similar to the first example, the determination of whether pixel-unit 15 in the fourth example, as shown in FIG. 24A, satisfies conditions 1-3 is described below. The determination of whether the fourth example satisfies conditions 1-3 is shown in FIGS. 24B to 24D. As shown in FIG. 24B, all pixels are shaded. Accordingly, it was determined that condition 1 was satisfied for the entire pixel-unit 15.

On the other hand, as shown in FIG. 24C, a few of the pixels are white, which is also shown in FIG. 24D. Accordingly, in the fourth example condition 2 is not satisfied for relatively few parts of the first areas 15′ and condition 3 is not satisfied for relatively many parts of the first areas 15′.

As described above, 30% of the pixels in the image sensor 10 of the fourth example are lengthened pixels. All first areas in the image sensor cannot satisfy conditions 2 and 3. As shown in FIG. 25, an optical image of diffraction light captured by the image sensor 10 having the first areas 15′ of the fourth example is greater than captured optical images of the first to third examples. In addition, the brightness of the optical image of the fourth example is greater than that of the first to third examples. However, the optical image is more blurred than that of the comparative example to be described later (see FIG. 33). Accordingly, the contrast of the diffractive light is substantially lower than that of the comparative example.

### Example 5

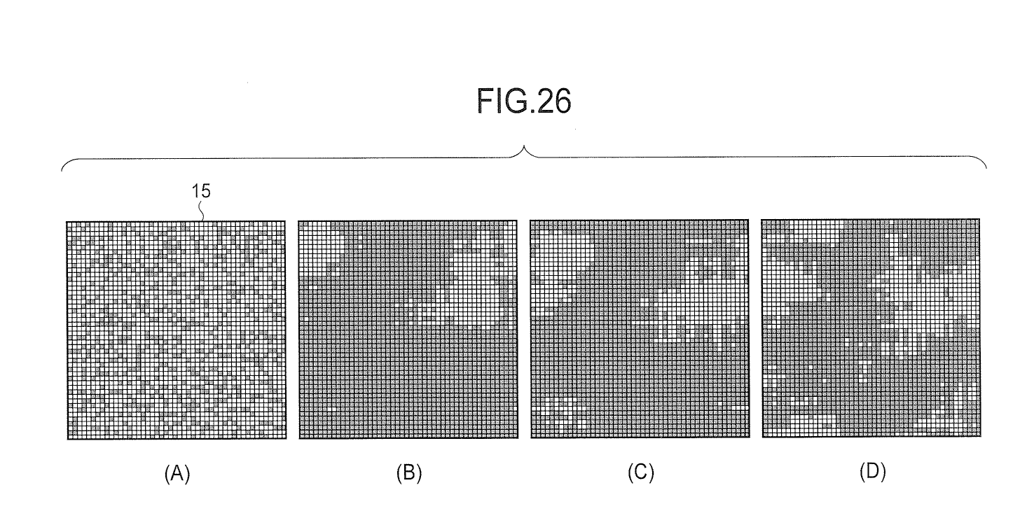

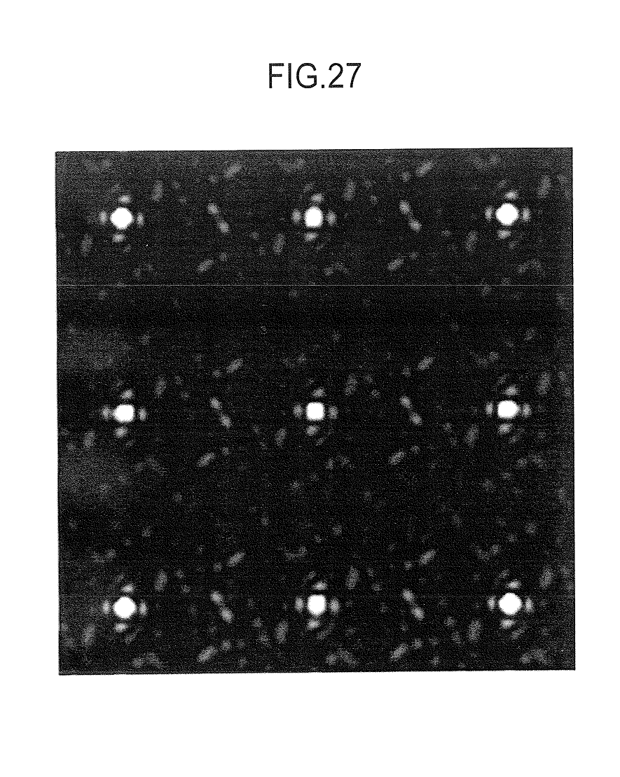

Next, the structure and effects of the fifth example are explained below. FIG. 26A is a deployment diagram showing the arrangement of the lengthened pixels in the pixel-unit of the fifth example. FIGS. 26B-24D show whether or not the ratio of lengthened pixels to all pixels in the first area is between 25% and 75%. FIG. 27 shows the contrast of the diffraction light of the fifth example.

As shown in FIG. 26A, pixels are arranged irregularly in 48 rows and columns in the pixel-unit 15 of the fifth example, similar to the above examples. In the fifth example, the lengthened pixels are arranged so that the number of the lengthened pixels account for 25% of all pixels in the pixel-unit 15, which is the area irregularity.

Similar to the first example, the determination of whether or not the pixel-unit 15 in the fifth example, as shown in FIG. 26A, satisfies conditions 1-3 is described below. The determination of whether the fifth example satisfies conditions 1-3 are shown in FIGS. 26B-26D. As shown in FIGS. 26B-26D, some of the pixels are white. Accordingly in the fifth example conditions 1-3 are not satisfied for some first areas 15′.

As described above, 25% of pixels in the image sensor 10 of the fifth example are lengthened pixels. All first areas in the image sensor cannot satisfy the conditions 1 to 3. As shown in FIG. 27, an optical image of diffraction light captured by the image sensor 10 having the first areas 15′ of the fifth example is greater than captured optical images in the first to fourth examples. In addition, the brightness of the optical image of the fifth example is greater than that of the first to fourth examples. However, the optical image is more blurred than that of the comparative example to be described later (see FIG. 33). Accordingly, the contrast of the diffraction light is substantially lower than that of the comparative example.

### Example 6

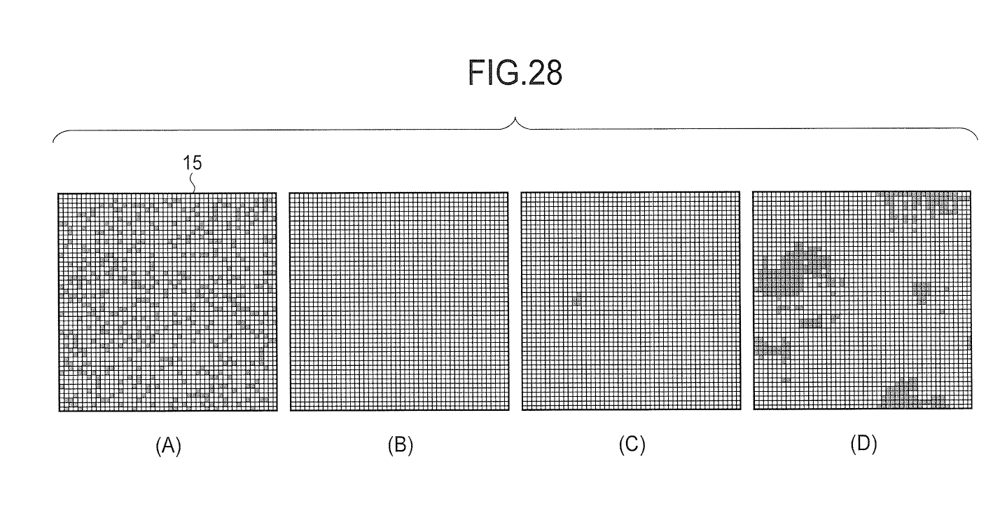

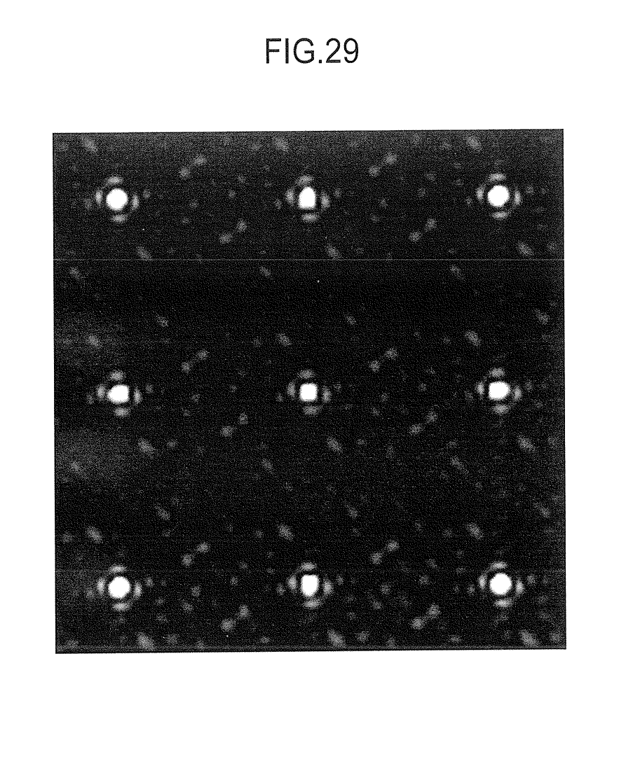

Next, the structure and effects of the sixth example are explained below. FIG. 28A is a deployment diagram showing the arrangement of the lengthened pixels in the pixel-unit of the sixth example. FIGS. 28B-28D show whether or not the ratio of lengthened pixels to all pixels in the first area is between 25% and 75%. FIG. 29 shows the contrast of the diffraction light of the sixth example.

As shown in FIG. 28A, pixels are arranged irregularly in 48 rows and columns in the pixel-unit 15 of the sixth example, similar to the above examples. In the sixth example, the lengthened pixels are arranged so that the number of the lengthened pixels account for 20% of all pixels in the pixel-unit 15, which is the area of irregularity.

Similar to the first example, the determination of whether or not the pixel-unit 15 in the sixth example, as shown in FIG. 28A, satisfies conditions 1-3 is described below. The determination of whether the sixth example satisfies the condition 1-3 is shown in FIGS. 28B-28D. As shown in FIG. 28B, all of the pixels are white. As shown in FIG. 28C, most of pixels are white. As shown in FIG. 28D, a majority of pixels are white. Accordingly, in the sixth example, condition 1 is not satisfied at all, condition 2 is barely satisfied, and condition 3 is not satisfied for the majority of first areas 15′ having centers containing all pixels.

As described above, 20% of pixels in the image sensor 10 of the sixth example are lengthened pixels. All first areas in the image sensor cannot satisfy the conditions 1 to 3. As shown in FIG. 29, an optical image of diffraction light captured by the image sensor 10 having the first areas 15′ of the sixth example is greater than the captured optical images of the first to fifth examples. In addition, the brightness of the optical image of the sixth example is greater than that of the first to fifth examples. However, the optical image is more blurred than that of the comparative example to be described later (see FIG. 33). Accordingly, the contrast of the diffraction light is substantially lower than that of the comparative example.

### Example 7

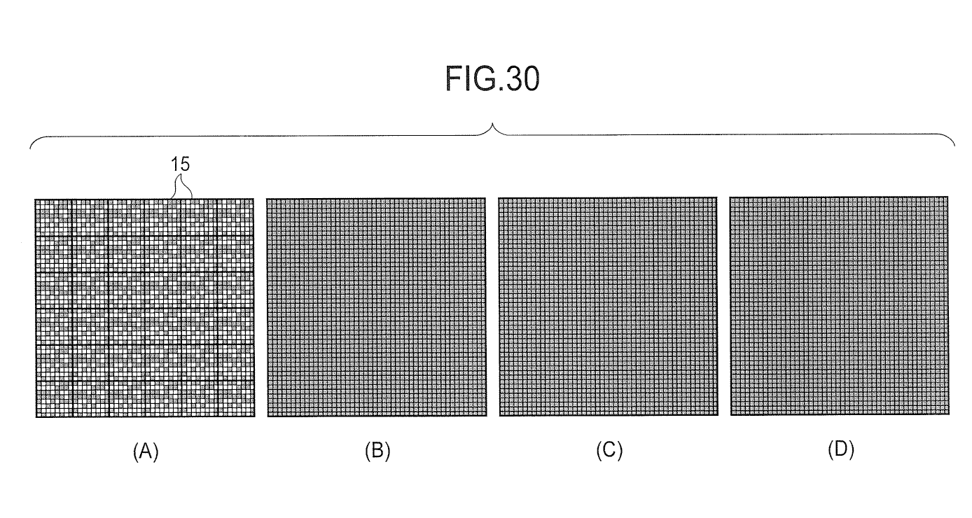

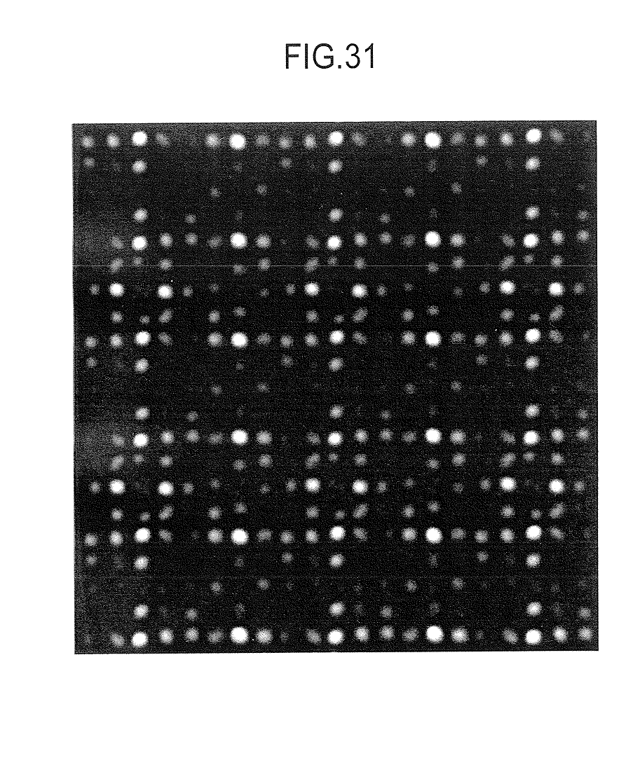

Next, the structure and the effect of the seventh example are explained below. FIG. 30A is a deployment diagram showing the arrangement of the lengthened pixels in the pixel-unit of the seventh example. FIGS. 30B-30D show whether or not the ratio of lengthened pixels to all pixels in the first area is between 25% and 75%. FIG. 31 shows the contrast of the diffraction light of the seventh example.

As shown in FIG. 30A, pixels are arranged irregularly in eight rows and columns in the pixel-unit 15 of the seventh example, which is different from the above examples. In addition, a plurality of pixel-units 15 is successively arranged so that they make contact with each other (see wide lines). In the seventh example, the lengthened pixels are arranged so that the number of the length added pixels account for 50% of all pixels in the pixel-unit 15, which is the area of irregularity.

Similar to the first example, the determination of whether or not the pixel-unit 15 in the sixth example, as shown in FIG. 30A, satisfies conditions 1-3 is described below. The determination of whether the seventh example satisfies conditions 1-3 are shown in FIGS. 30B to 30D. As shown in FIGS. 30B to 30D, all pixels are shaded. Accordingly, it was determined that conditions 1-3 were satisfied for the entire pixel-unit 15.

As described above, the image sensor in the seventh example can satisfy conditions 1-3. As shown in FIG. 33, an optical image of diffraction light captured by the image sensor 10 having the first areas 15′ of the seventh example, of which 50% of its pixels are lengthened pixels, is more blurred than that of the comparative example to be described later (see FIG. 33). Accordingly, the contrast of the diffraction light is substantially lower than that of the comparative example.

### Comparative Example

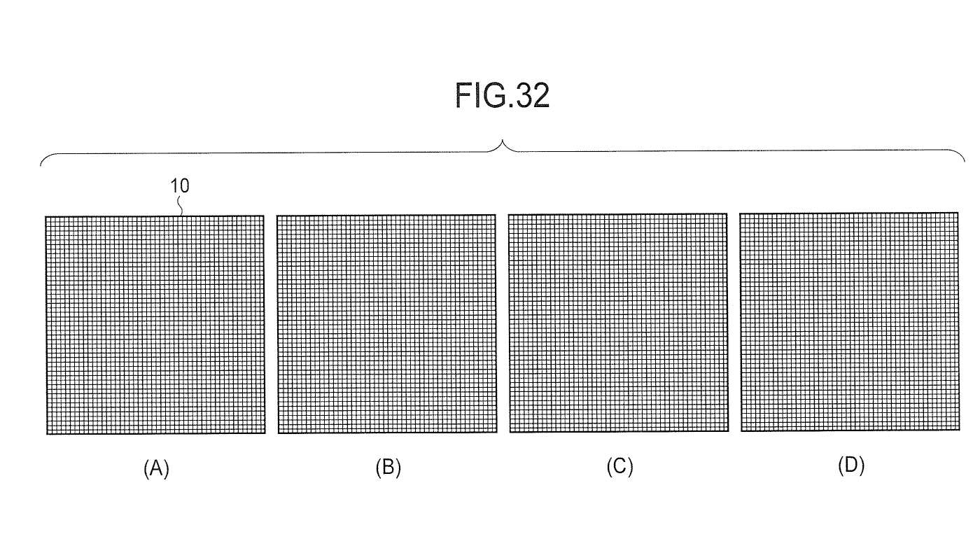

Next, the structure of the comparative example is explained below. FIG. 32A is a deployment diagram showing the arrangement of the lengthened pixels in the pixel-unit of the comparative example. FIGS. 32B-32D show whether or not the ratio of lengthened pixels to all pixels in the first area is between 25% and 75%. FIG. 33 shows the contrast of the diffraction light of the comparative example.

As shown in FIG. 32A, the pixel-unit 15′ is not formed on the image sensor 10 in the comparative example. In addition, only the normal pixels are arranged on the image sensor 10.

Similar to the first example, the determination of whether or not the arrangement of pixels in the comparative example, as shown in FIG. 32A, satisfies conditions 1-3 is described below. The determination of whether the comparative example satisfies conditions 1-3 is shown in FIGS. 32B-32D. As shown in FIGS. 32B-32D, all pixels are white. Accordingly, it was determined that conditions 1-3 were not satisfied in the comparative example.

In addition, as shown in FIG. 23, an optical image of diffraction light captured by the image sensor 10 having only the normal pixels of the comparative example is greater than the captured optical images of the above examples. These results are based on the understanding that the pairs of pixels having the e-r-difference are not mixed in the comparative example.

Under the assumption that the contrast of the diffraction light in the comparative example is 1, the relative contrast of the diffraction light in the above first to seventh examples were calculated and presented in table 1.

TABLE 1

| | Relative Contrast |
|---|---|
| First Example | 0.020 |
| Second Example | 0.028 |
| Third Example | 0.126 |
| Fourth Example | 0.200 |
| Fifth Example | 0.330 |
| Sixth Example | 0.342 |
| Seventh Example | 0.053 |
| Comparative Example | 1.000 |

It is clear from the results of the relative contrasts of the first-seventh examples and the comparative example that the contrast of the r-d-ghost image can be reduced by arranging the lengthened pixels in the pixel-unit 15 so that the ratio of lengthened pixels to all pixels is between 25% and 70%.

In addition, it is proven from the above relative contrasts that the effect of reducing the contrast is improved as the ratio of lengthened pixels to all pixels approaches 50%. For example, the effect of reducing the contrast by mixing between 40% to 60% lengthened pixels is greater than the effect achieved by mixing either less than 40% or more than 60% of the lengthened pixels. Moreover, the effect is greatest when the ratio of lengthened pixels to all pixels is 50% (first example).

In addition, by comparing the first and seventh examples, it is confirmed that the effect of reducing the contrast can be increased by making the size of the pixel-unit 15 larger than a certain size. To say concretely, it is preferable that the size be larger than that of the optical image of the sun including the circle of confusion.

However, even in the seventh embodiment having the small pixel-unit 15, a reduction in the contrast can be relatively effectively achieved. In addition, there are some effects derived from the small pixel-unit 15, as described above. Accordingly, a plurality of pixel-units 15 where a plurality of pixels are arranged in 8-12 rows and columns may be mounted on the image sensor 10.

In addition, it is confirmed that the contrast of the r-d-ghost image is reduced by satisfying the above conditions 1-3. In other words, it is confirmed that the contrast is reduced when the ratio of lengthened pixels to all pixels is between 25% and 75% for a pixel-unit 15 having the size of the optical image of the sun including the circle of confusion, also for a pixel-unit 15 having the size of the optical image of the sun without the circle of confusion, and for a pixel-unit 15 having one-half the size of the optical image of the sun.

In addition, considering that the effect of reducing the contrast is achieved in the sixth example, the contrast can be effectively reduced when the lengthened pixels are arranged in entire pixel-unit 15 so that the ratio of lengthened pixels to all pixels is between 25% and 75%.

Although the embodiments of the present invention have been described herein with reference to the accompanying drawings, obviously many modifications and changes may be made by those skilled in this art without departing from the scope of the invention.

The present disclosure relates to subject matters contained in Japanese Patent Applications No. 2009-296284 (filed on Dec. 25, 2009) and No. 2010-144077 (filed on Jun. 24, 2010), which are expressly incorporated herein, by references, in their entireties.

1. An image sensor comprising a plurality of pixels that comprises photoelectric converters and optical members, the optical member covering the photoelectric converter, light toward the photoelectric converter passing through the optical member, the pixels being arranged in two dimensions on a light-receiving area,
at least a part of the light-receiving area comprising an area of irregularity, first and second pixels being arranged irregularly in the area of irregularity, the thickness of the optical members of the first and second pixels being first and second thicknesses, the second thickness being thinner than the first thickness.

2. An image sensor according to claim 1, wherein a distance between the photoelectric converter and a far-side surface of the optical member is equal in the first and second pixels, respectively, the far-side surface is an opposite surface of a near-side surface, and the near-side surface of the optical member faces the photoelectric converter.

3. An image sensor comprising a plurality of pixels that comprise photoelectric converters and optical members, the optical member covering the photoelectric converter, light toward the photoelectric converter passing through the optical member, the pixels being arranged in two dimensions on a light-receiving area,
at least part of the light-receiving area comprising an area of irregularity, first and second pixels being arranged irregularly in the area of irregularity, distances between the photoelectric converter and a far-side surface of the optical member being first and second distances in the first and second pixels, respectively, the far-side surface being an opposite surface of a near-side surface, the near-side surface of the optical member facing the photoelectric converter, the second distance being shorter than the first distance.

4. An image sensor according to claim 2, wherein the thickness of the optical member of the first and second pixels are a first and second thickness, respectively, the second thickness is thinner than the first thickness, and the distances between the photoelectric converter and the near-side surface of the optical member in the first and second pixels are equal.

5. An image sensor according to claim 1, further comprising a pixel-unit as the area of irregularity, a plurality of the pixel-units being arranged on the light-receiving are, the arrangement of the first and second pixels in each of the pixel-units is the same.

6. An image sensor according to claim 5, wherein the ratio of first pixels to all pixels in the pixel-unit is between 25% and 75%.

7. An image sensor according to claim 6, wherein the ratio of first pixels to all pixels in the pixel-unit is between 40% and 60%.

8. An image sensor according to claim 7, wherein the number of first and second pixels are equal.

9. An image sensor according to claim 5, wherein the ratio of first pixels is between 25% and 75% in any target zone, the target zone is freely selected in the pixel-unit, the pixels are arranged in N1 rows and columns, N1 is calculated as N1=INT(M×0.0063), and M is the number of pixels arranged in a horizontal row on the image sensor.

10. An image sensor according to claim 5, wherein the ratio of first pixels is between 25% and 75% in any target zone, the target zone is freely selected in the pixel-unit, the pixels are arranged in N1 rows and columns, N1 is calculated as N1=INT(M×0.0053), and M is the number of the pixels arranged in a row on the image sensor.

11. An image sensor according to claim 5, wherein the ratio of first pixels is between 25% and 75% in any target zone, the target zone is freely selected in the pixel-unit, the pixels are arranged in N1 rows and columns, N1 is calculated as N1=INT(M×0.0027), and N is the number of pixels arranged in a row on the image sensor.

12. An image sensor according to claim 5, wherein the pixel-unit comprises a plurality of pixels arranged in N2 rows and columns, N2 is greater than or equal to (M×0.011), M is the number of pixels arranged in a row on the image sensor.

13. An image sensor according to claim 3, wherein the difference between the first and second distances is 0.5×(m1+½)×λ, m1 is an integer, and λ is the wavelength of the light incident on the optical member.

14. An image sensor according to claim 3, wherein the difference between the first and second distances is greater than 0.5×(m2+¼)×λm and less than 0.5×(m2+¾)×λm, m2 is an integer, and λm is a practical middle point of the wavelengths in the band of light incident on the optical member.

15. An image sensor according to claim 3, wherein the difference between the first and second distances is between 200 nm and 350 nm.

16. An image sensor according to claim 15, wherein the difference between the first and second distances is between 250 nm and 300 nm.

17. An image sensor according to claim 2, wherein the difference between the first and second distances is 0.5×(m3+½)×λ/n, m3 is an integer, λ is a wavelength of the light incident on the optical member, and n is a refractive index of the optical member.

18. An image sensor according to claim 2, wherein the difference between the first and second thickness is greater than 0.5×(m4+¼)×λm/n and less than 0.5×(m4+¾)×λm/n, m4 is an integer, λm is a practical middle point of the wavelengths in the band of light incident on the optical member, and n is a refractive index of the optical member.

19. An image sensor according to claim 4, wherein the difference between the first and second thickness is 0.5×((m5+½)×λ)/(n−1), m5 is an integer, λ is a wavelength of the light incident on the optical member, and n is a refractive index of the optical member.

20. An image sensor according to claim 4, wherein the difference between the first and second thickness is greater than 0.5×((m6+¼)×λm)/(n−1) and less than 0.5×((m6+¾)×λm)/(n−1), m6 is an integer, λm is a practical middle point of the wavelengths in the band of light incident on the optical member, and n is a refractive index of the optical member.

21. An image sensor according to claim 1, wherein the difference between the first and second thickness is between 200 nm and 350 nm.

22. An image sensor according to claim 21, wherein the difference between the first and second thickness is between 250 nm and 300 nm.

23. An image sensor according to claim 13, wherein λ is greater than or equal to 0.5×λm and less than or equal to 1.5×λm, and λm is a practical middle point of the wavelengths in the band of light incident on the optical member.

24. An image sensor according to claim 1, wherein the optical member is a micro lens.

25. An image sensor according to claim 1, further comprising a micro lens, the micro lens being mounted in each of the pixels, the optical member covering the micro lens, the optical member being made of light-transmissible material.

26. An image sensor according to claim 24, wherein a micro-lens array is formed as one body so that the micro lens-array comprises a plurality of micro lenses.

27. An image sensor according to claim 25, wherein a plate is formed as one body so that the plate comprises a plurality of optical members, the plate has flat and uneven surfaces, the uneven surface has a plurality of convex and concave zones, each of the convex and concave zones face each of the pixels, and each of the convex and concave zones is an optical member.

28. An image sensor according to claim 1, further comprising first and second micro lenses mounted in the first and second pixels, respectively, the optical member of the second pixel is made of light-transmissible material which is either separate from or in contact with the second micro lens.

29. An image sensor according to claim 3, further comprising first and second color filters,
the difference between the first and second distances of the first and second pixels upon which the first color filter is mounted is 0.5×((m7+½)×λ1)/(n−1), m7 is an integer, λ1 is a wavelength of light that passes through the first color filter, n is a refractive index of the optical member,
the difference between the first and second distances of the first and second pixels upon which the second color filter is mounted is 0.5×((m8+½)×λ2)/(n−1), m8 is an integer, λ2 is wavelength of light that passes through the second color filter.

30. An imaging sensor comprising a plurality of pixels that comprises photoelectric converters and optical members, the optical member covering the photoelectric converter, incoming light toward the photoelectric converter passing through the optical member, the pixels being arranged in two dimensions on a light-receiving area,
at least part of the light-receiving area comprising an area of irregularity, first and second pixels being arranged irregularly in the area of irregularity, distances between the photoelectric converter and a near-side surface of the optical member being first and second distances in the first and second pixels, respectively, the near-side surface of the optical member facing the photoelectric converter, the second distance being shorter than the first distance.

31. An imaging apparatus comprising an image sensor according to claim 12.
